(19) United States
(12) Patent Application Publication
(10) Pub. No.: US 2026/0002661 A1
(43) Pub. Date: Jan. 1, 2026

(54) CONTROL DEVICE FOR ILLUMINATION DEVICE

(71) Applicant: Japan Display Inc., Tokyo (JP)

(72) Inventors: Masashi TAKAHATA, Tokyo (JP); Chiehan CHIEN, Tokyo (JP)

(21) Appl. No.: 19/320,498

(22) Filed: Sep. 5, 2025

Related U.S. Application Data
(63) Continuation of application No. PCT/JP2024/000354, filed on Jan. 11, 2024.

(30) Foreign Application Priority Data
Mar. 9, 2023 (JP) 2023-036889

(51) Int. Cl. F21V 23/04; F21V 14/00

(52) U.S. Cl. CPC F21V 23/0471; F21V 14/003; F21V 23/0435

(57) ABSTRACT

A control device for an illumination device is configured to control an illumination device by controlling a diffusion degree of light emitted from a light source. The control device includes: a touch sensor having a detection region; and a display panel provided with a display region overlapping the detection region of the touch sensor in plan view. A determination region provided in the detection region and configured to detect a predetermined touch operation. Touch operations to be detected in the determination region include a first touch operation defined by at least one of the number of touches or the duration of touch in the determination region and a second touch operation different from the first touch operation. The diffusion degree of the illumination device is increased when the first touch operation is detected. The diffusion degree of the illumination device is decreased when the second touch operation is detected.

### CROSS-REFERENCE TO RELATED APPLICATION

This application claims the benefit of priority from Japanese Patent Application No. 2023-036889 filed on Mar. 9, 2023 and International Patent Application No. PCT/JP2024/000354 filed on Jan. 11, 2024, the entire contents of which are incorporated herein by reference.

### BACKGROUND

### 1. Technical Field

What is disclosed herein relates to a control device for an illumination device.

### 2. Description of the Related Art

In a conventional illumination instrument, a light source such as an LED is combined with a thin lens provided with a prism pattern, and the distance between the light source and the thin lens is changed to change a light distribution angle. For example, an illumination instrument is disclosed (refer to Japanese Patent Application Laid-open Publication No. H02-065001, for example) in which the front of a transparent light bulb is covered by a liquid crystal light adjustment element, and the transmittance of a liquid crystal layer is changed to switch between directly-reaching light and scattering light.

For example, in an illumination device including a liquid crystal cell for p-wave polarization and a liquid crystal cell for s-wave polarization, the diffusion degree of light in two directions can be controlled by driving the respective liquid crystal cells. In such an illumination device controllable with respect to the diffusion degree of light in two directions, it is needed, with a conventional adjustment method of detecting a touch position on the screen of a smartphone, a tablet, or the like and adjusting the diffusion degree, for example, to individually adjust the diffusion degree of light in two directions when the irradiation area of light is enlarged or reduced while a light distribution shape is maintained. Thus, there is a demand for a control device with which a user can more intuitively enlarge and reduce the irradiation area of light.

For the foregoing reasons, there is a need for a control device for an illumination device capable of changing the irradiation area of light intuitively.

### SUMMARY

According to an aspect, a control device for an illumination device is configured to control an illumination device that is changeable with respect to an irradiation area by controlling a diffusion degree of light emitted from a light source. The control device includes: a touch sensor having a detection region provided with detection elements; and a display panel provided with a display region overlapping the detection region of the touch sensor in plan view. A determination region provided in the detection region and configured to detect a predetermined touch operation. Touch operations to be detected in the determination region include a first touch operation defined by at least one of the number of touches or the duration of touch in the determination region and a second touch operation different from the first touch operation. The diffusion degree of the illumination device is increased when the first touch operation is detected.

The diffusion degree of the illumination device is decreased when the second touch operation is detected.

### BRIEF DESCRIPTION OF THE DRAWINGS

FIG. 1A is a side view illustrating an example of an illumination device according to an embodiment;

FIG. 1B is a perspective view illustrating an example of an optical element according to the embodiment;

FIG. 2 is a schematic plan view of a first substrate when viewed in a Dz direction;

FIG. 3 is a schematic plan view of a second substrate when viewed in the Dz direction;

FIG. 4 is a see-through diagram of a liquid crystal cell in which the first substrate and the second substrate are stacked in the Dz direction;

FIG. 5 is a cross-sectional view along line A-A′ illustrated in FIG. 4;

FIG. 6A is a diagram illustrating the alignment direction of an alignment film of the first substrate;

FIG. 6B is a diagram illustrating the alignment direction of an alignment film of the second substrate;

FIG. 7 is a multilayered structure diagram of the optical element according to the embodiment;

FIG. 8A is a conceptual diagram for description of change in shape of light by the optical element according to the embodiment;

FIG. 8B is a conceptual diagram for description of change in shape of light by the optical element according to the embodiment;

FIG. 8C is a conceptual diagram for description of change in shape of light by the optical element according to the embodiment;

FIG. 8D is a conceptual diagram for description of change in shape of light by the optical element according to the embodiment;

FIG. 9 is a conceptual diagram for conceptually describing control of the light diffusion degree of the illumination device according to the embodiment;

FIG. 10 is a schematic view illustrating an example of the configuration of an illumination system according to the embodiment;

FIG. 11 is an exterior diagram illustrating an example of a control device according to the embodiment;

FIG. 12 is a conceptual diagram illustrating an example of a detection region of a touch sensor;

FIG. 13 is a diagram illustrating an example of a control block configuration of the control device;

FIG. 14 is a diagram illustrating an example of a control block configuration of the illumination device;

FIG. 15 is a conceptual diagram illustrating an example of the display aspect of an illumination control application screen;

FIG. 16 is a diagram for description of the relation between a position on the illumination control application screen and the diffusion degree;

FIG. 17A is a diagram illustrating an example of a shape change of a light distribution shape object in a case where a determination region is double-tapped on the illumination control application screen;

FIG. 17B is a diagram illustrating an example of a shape change of the light distribution shape object in a case where the determination region is long-tapped on the illumination control application screen;

FIG. 18A is a diagram illustrating an example of data used in an illumination control application;

FIG. 18B is a diagram illustrating an example of data used in the illumination control application;

FIG. 18C is a diagram illustrating an example of data used in the illumination control application;

FIG. 18D is a diagram illustrating an example of data used in the illumination control application;

FIG. 18E is a diagram illustrating an example of data used in the illumination control application;

FIG. 18F is a diagram illustrating a specific example of a conversion table;

FIG. 18G is a diagram illustrating a specific example of the conversion table;

FIG. 19 is a flowchart illustrating an example of initial setting processing of the illumination control application;

FIG. 20 is a flowchart illustrating an example of the overall sequence of illumination control processing by the control device according to the embodiment;

FIG. 21 is a flowchart illustrating an example of conversion table generation processing;

FIG. 22 is a flowchart illustrating an example of horizontal diffusion degree adjustment processing;

FIG. 23 is a flowchart illustrating an example of vertical diffusion degree adjustment processing;

FIG. 24 is a flowchart illustrating an example of enlargement processing; and

FIG. 25 is a flowchart illustrating an example of reduction processing.

### DETAILED DESCRIPTION

Aspects (embodiments) of the present disclosure will be described below in detail with reference to the accompanying drawings. Contents described below in the embodiments do not limit the present disclosure. Components described below include those that could be easily thought of by the skilled person in the art and those identical in effect. Components described below may be combined as appropriate. What is disclosed herein is merely exemplary, and any modification that could be easily thought of by the skilled person in the art as appropriate without departing from the gist of the disclosure is contained in the scope of the present disclosure. For clearer description, the drawings are schematically illustrated for the width, thickness, shape, and the like of each component as compared to an actual aspect in some cases, but the drawings are merely exemplary and do not limit interpretation of the present disclosure. In the present specification and drawings, any element same as that already described with reference to an already described drawing is denoted by the same reference sign, and detailed description thereof is omitted as appropriate in some cases.

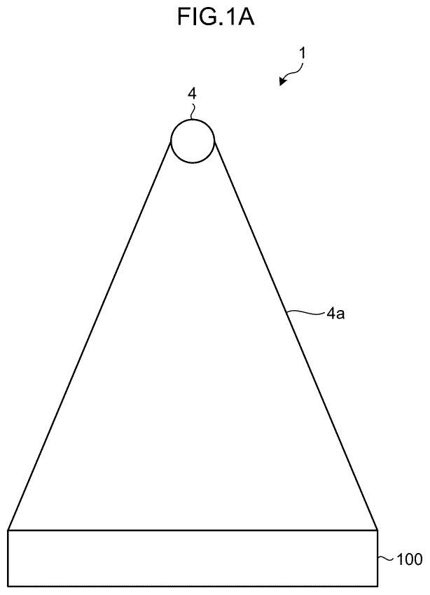

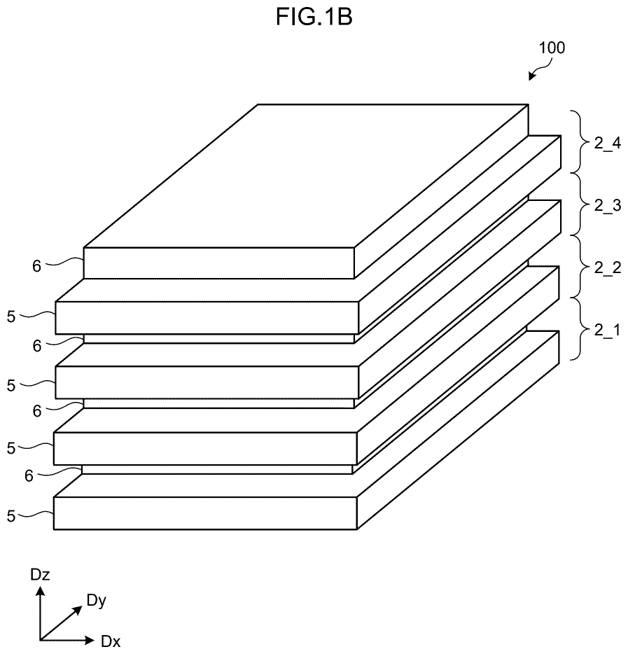

FIG. 1A is a side view illustrating an example of an illumination device 1 according to an embodiment. FIG. 1B is a perspective view illustrating an example of an optical element 100 according to the embodiment. As illustrated in FIG. 1A, the illumination device 1 includes a light source 4, a reflector 4a, and the optical element 100. As illustrated in FIG. 1B, the optical element 100 includes a first liquid crystal cell 2_1, a second liquid crystal cell 2_2, a third liquid crystal cell 2_3, and a fourth liquid crystal cell 2_4. The light source 4 is configured with, for example, a light emitting diode (LED). The reflector 4a is a component that condenses light from the light source 4 to the optical element 100.

In FIG. 1B, a Dz direction indicates the emission direction of light from the light source 4 and the reflector 4a. The optical element 100 has a configuration in which the first liquid crystal cell 2_1, the second liquid crystal cell 2_2, the third liquid crystal cell 2_3, and the fourth liquid crystal cell 2_4 are stacked in the Dz direction. In the present disclosure, the optical element 100 has a configuration in which the first liquid crystal cell 2_1, the second liquid crystal cell 2_2, the third liquid crystal cell 2_3, and the fourth liquid crystal cell 2_4 are sequentially stacked from the light source 4 side (lower side in FIG. 1B). In FIG. 1B, one direction in a plane orthogonal to the Dz direction and parallel to stacking surfaces of the first liquid crystal cell 2_1, the second liquid crystal cell 2_2, the third liquid crystal cell 2_3, and the fourth liquid crystal cell 2_4 is defined as a Dx direction (first direction), and a direction orthogonal to both the Dx direction and the Dz direction is defined as a Dy direction (second direction).

The first liquid crystal cell 2_1, the second liquid crystal cell 2_2, the third liquid crystal cell 2_3, and the fourth liquid crystal cell 2_4 have the same configuration. In the present disclosure, the first liquid crystal cell 2_1 and the fourth liquid crystal cell 2_4 are liquid crystal cells for p-wave polarization. The second liquid crystal cell 2_2 and the third liquid crystal cell 2_3 are liquid crystal cells for s-wave polarization. Hereinafter, the first liquid crystal cell 2_1, the second liquid crystal cell 2_2, the third liquid crystal cell 2_3, and the fourth liquid crystal cell 2_4 are also collectively referred to as “liquid crystal cells 2”.

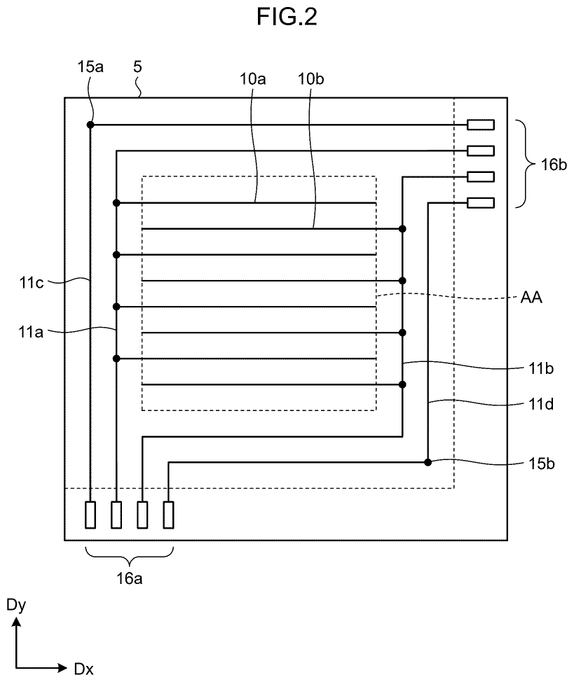

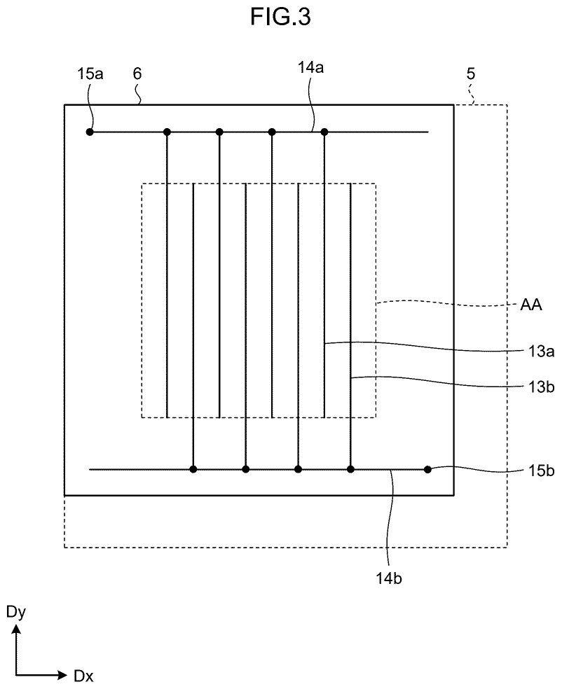

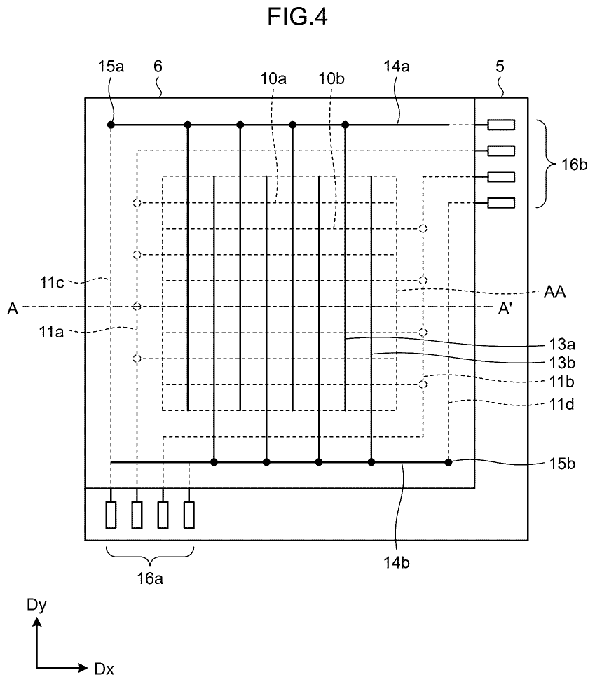

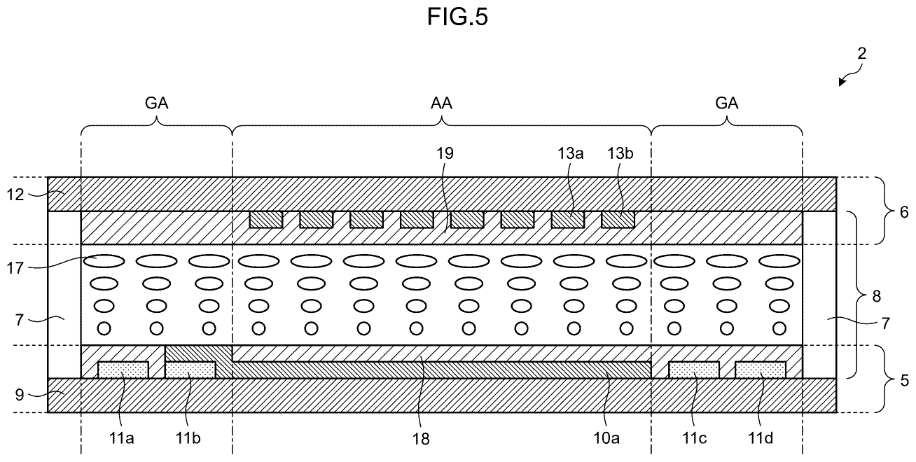

Each liquid crystal cell 2 includes a first substrate 5 and a second substrate 6. FIG. 2 is a schematic plan view of the first substrate 5 when viewed in the Dz direction. FIG. 3 is a schematic plan view of the second substrate 6 when viewed in the Dz direction. In FIG. 3, drive electrodes are visible through the substrates, but for clarity, the drive electrodes and wiring lines are illustrated with solid lines. FIG. 4 is a see-through view of a liquid crystal cell in which the first substrate 5 and the second substrate 6 are stacked in the Dz direction. In FIG. 4 as well, for clarity, drive electrodes and wiring lines on the second substrate side are illustrated with solid lines, and drive electrodes and wiring lines on the first substrate side are illustrated with dotted lines. FIG. 5 is a sectional view along line A-A′ illustrated in FIG. 4. FIGS. 2, 3, 4, and 5 exemplarily illustrate the third liquid crystal cell 2_3 and the fourth liquid crystal cell 2_4 in which drive electrodes 10a and 10b of the first substrate 5 extend in the Dx direction and drive electrodes 13a and 13b of the second substrate 6 extend in the Dy direction.

As illustrated in FIG. 5, the liquid crystal cell 2 includes a liquid crystal layer 8 sealed around its periphery by a sealing member 7 between the first substrate 5 and the second substrate 6.

The liquid crystal layer 8 modulates light passing through the liquid crystal layer 8 in accordance with the state of electric field. As liquid crystal molecules, positive-type nematic liquid crystals are used, but other liquid crystals with the same effects may be used.

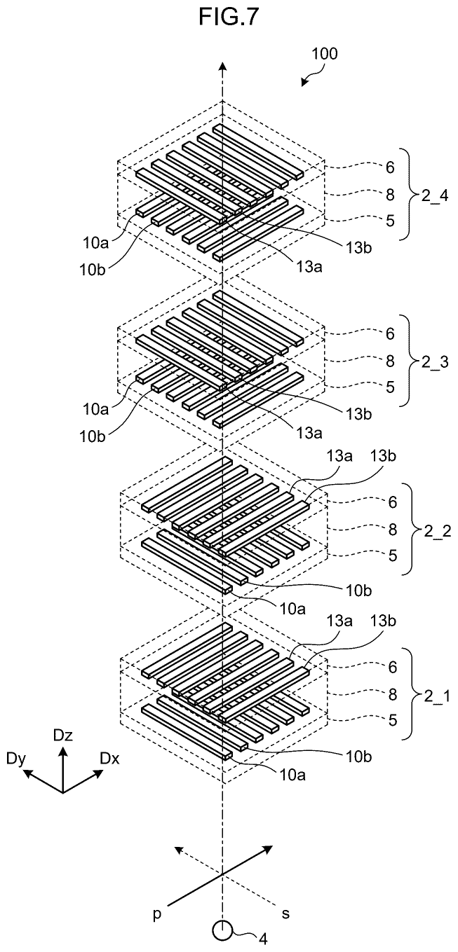

As illustrated in FIG. 2, the drive electrodes 10a and 10b, metal lines 11a and 11b, and metal lines 11c and 11d are provided on the liquid crystal layer 8 side of a base material 9 of the first substrate 5. The metal lines 11a and 11b supply drive voltage that is applied to the drive electrodes 10a and 10b, and the metal lines 11c and 11d supply drive voltage that is applied to the drive electrodes 13a and 13b (refer to FIG. 3) provided on the second substrate 6 to be described later. The metal lines 11a, 11b, 11c, and 11d are provided in a wiring layer of the first substrate 5. The metal lines 11a, 11b, 11c, and 11d are provided to be spaced apart in the wiring layer on the first substrate 5. Hereinafter, the drive electrodes 10a and 10b are simply referred to as “drive electrodes 10” in some cases. The metal lines 11a, 11b, 11c, and 11d are referred to as “first metal lines 11” in some cases. As illustrated in FIGS. 2 and 7, in the third liquid crystal cell 2_3 and the fourth liquid crystal cell 2_4, the drive electrodes 10 on the first substrate 5 extend in the Dx direction. In the first liquid crystal cell 2_1 and the second liquid crystal cell 2_2, the drive electrodes 10 on the first substrate 5 extend in the Dy direction.

As illustrated in FIG. 3, the drive electrodes 13a and 13b, and a plurality of metal lines 14a and 14b that supply drive voltage applied to the drive electrodes 13 are provided on the liquid crystal layer 8 side of a base material 12 of the second substrate 6 illustrated in FIG. 5. The metal lines 14a and 14b are provided in a wiring layer of the second substrate 6. The metal lines 14a and 14b are provided to be spaced apart in the wiring layer on the second substrate 6. Hereinafter, the drive electrodes 13a and 13b are simply referred to as “drive electrodes 13” in some cases. The metal lines 14a and 14b are referred to as “second metal lines 14” in some cases. As illustrated in FIGS. 3 and 7, in the third liquid crystal cell 2_3 and the fourth liquid crystal cell 2_4, the drive electrodes 13 on the second substrate 6 extend in the Dy direction. In the first liquid crystal cell 2_1 and the second liquid crystal cell 2_2, the drive electrodes 13 on the second substrate 6 extend in the Dx direction.

The drive electrodes 10 and the drive electrodes 13 are light-transmitting electrodes formed of a light-transmitting conductive material (light-transmitting conductive oxide) such as indium tin oxide (ITO). The first substrate 5 and the second substrate 6 are light-transmitting substrates such as glass or resin. The first metal lines 11 and the second metal lines 14 are formed of at least one metallic material selected from aluminum (Al), copper (Cu), silver (Ag), molybdenum (Mo), and alloys thereof. The first metal lines 11 and the second metal lines 14 may be stacked bodies of a plurality of layers using one or more of these metallic materials. At least one metallic material selected from aluminum (Al), copper (Cu), silver (Ag), molybdenum (Mo), and alloys thereof has lower resistance than light-transmitting conductive oxide such as ITO.

The metal line 11c of the first substrate 5 and the metal line 14a of the second substrate 6 are coupled by a conduction part 15a made of, for example, conductive paste. The metal line 11d of the first substrate 5 and the metal line 14b of the second substrate 6 are coupled by a conduction part 15b made of, for example, conductive paste.

Coupling (flex-on-board) terminal parts 16a and 16b that are coupled to non-illustrated flexible printed circuits (FPC) are provided in regions on the first substrate 5, which do not overlap the second substrate 6 when viewed in the Dz direction. The coupling terminal parts 16a and 16b each include four coupling terminals corresponding to the metal lines 11a, 11b, 11c, and 11d, respectively.

The coupling terminal parts 16a and 16b are provided in the wiring layer of the first substrate 5. Drive voltage to be applied to the drive electrodes 10a and 10b on the first substrate 5 and the drive electrodes 13a and 13b on the second substrate 6 is supplied to the liquid crystal cell 2 from an FPC coupled to the coupling terminal part 16a or the coupling terminal part 16b. Hereinafter, the coupling terminal parts 16a and 16b are simply referred to as “coupling terminal parts 16” in some cases.

As illustrated in FIG. 4, in the liquid crystal cell 2, the first substrate 5 and the second substrate 6 are stacked in the Dz direction (irradiation direction of light), and the drive electrodes 10 on the first substrate 5 intersect the drive electrodes 13 on the second substrate 6 when viewed in the Dz direction. In the liquid crystal cell 2 thus configured, the alignment direction of liquid crystal molecules 17 in the liquid crystal layer 8 can be controlled by supplying drive voltage to the drive electrodes 10 on the first substrate 5 and the drive electrodes 13 on the second substrate 6. A region in which the alignment direction of the liquid crystal molecules 17 in the liquid crystal layer 8 can be controlled is referred to as an “effective region AA”. The refractive index distribution of the liquid crystal layer 8 is changed in the effective region AA, whereby the diffusion degree of light transmitted through the effective region AA of the liquid crystal cell 2 can be controlled. A region outside the effective region AA, where the liquid crystal layer 8 is sealed by the sealing member 7, is referred to as a “peripheral region GA” (refer to FIG. 5).

As illustrated in FIG. 5, the drive electrodes 10 (in FIG. 5, the drive electrode 10a) in the effective region AA of the first substrate 5 are covered by an alignment film 18. The drive electrodes 13 (in FIG. 5, the drive electrodes 13a and 13b) in the effective region AA of the second substrate 6 are covered by an alignment film 19. The alignment direction of the liquid crystal molecules is different between the alignment film 18 and the alignment film 19.

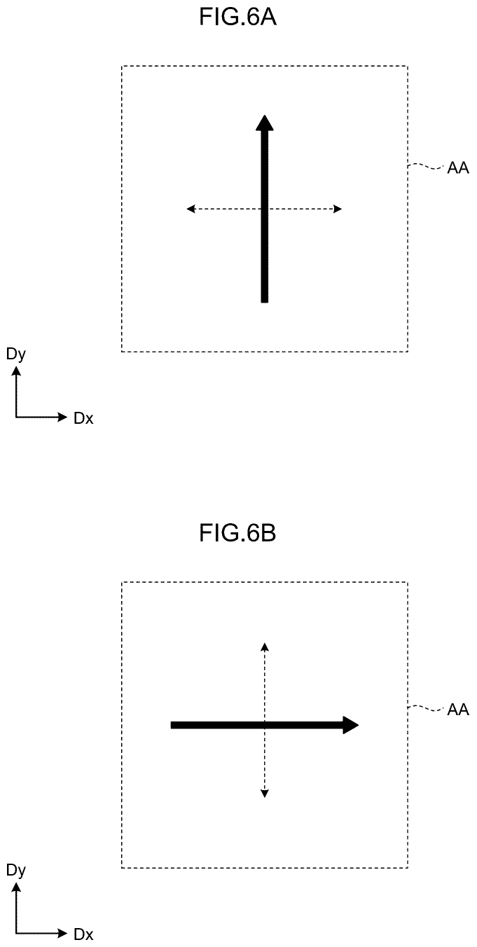

FIG. 6A is a diagram illustrating the alignment direction of the alignment film of the first substrate 5. FIG. 6B is a diagram illustrating the alignment direction of the alignment film of the second substrate 6.

As illustrated in FIGS. 6A and 6B, the alignment direction of the alignment film 18 of the first substrate 5 and the alignment direction of the alignment film 19 of the second substrate 6 are directions intersecting each other in plan view. Specifically, as illustrated with a solid arrow in FIG. 6A, the alignment direction of the alignment film 18 of the first substrate 5 is orthogonal to the extending direction of the drive electrodes 10a and 10b, which is illustrated with a dashed arrow in FIG. 6A. As illustrated with a solid arrow in FIG. 6B, the alignment direction of the alignment film 19 of the second substrate 6 is orthogonal to the extending direction of the drive electrodes 13a and 13b, which is illustrated with a dashed arrow in FIG. 6B. In the following description, the extending directions of the drive electrodes 10 and 13 are orthogonal to the alignment directions of the alignment films 18 and 19 covering them, but these may intersect at an angle other than being orthogonal, for example, in the angle range of 85° to 90°. The drive electrodes 10 on the first substrate 5 side and the drive electrodes 13 on the second substrate 6 side are preferably orthogonal to each other but may intersect, for example, in the angle range of 85° to 90°. The alignment directions of the alignment films 18 and 19 are formed by rubbing processing or light alignment processing.

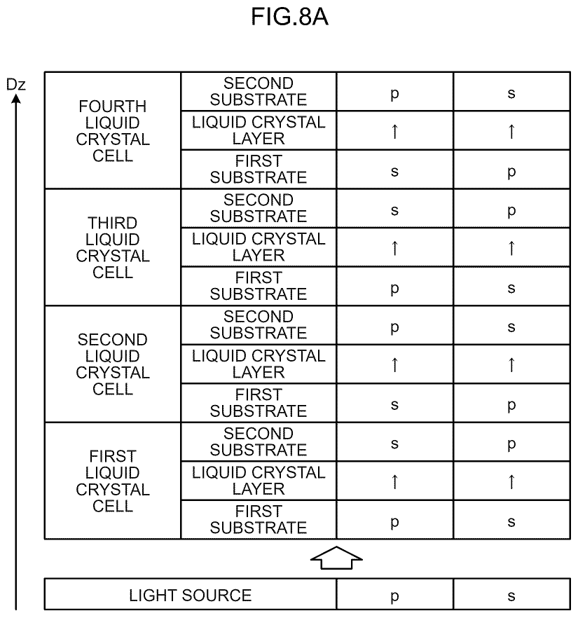

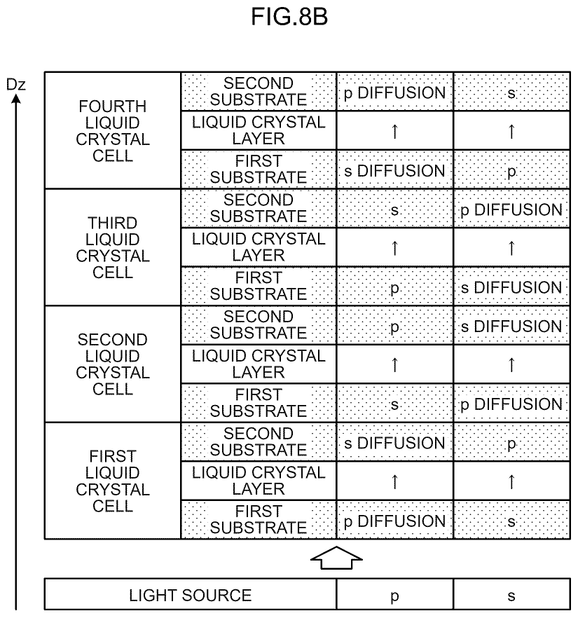

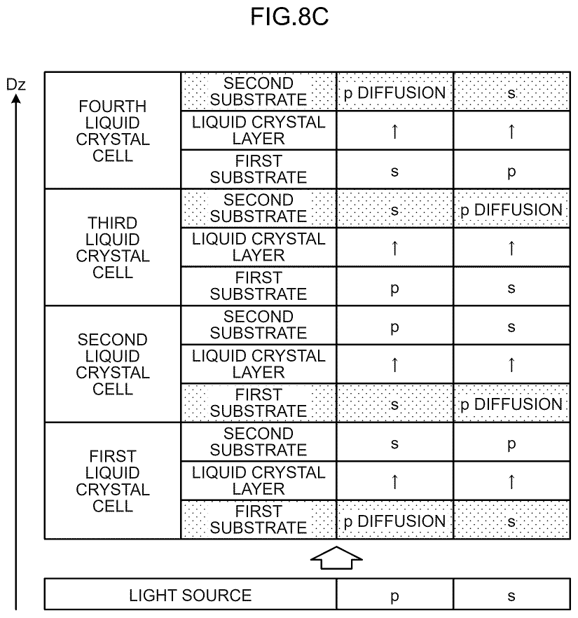

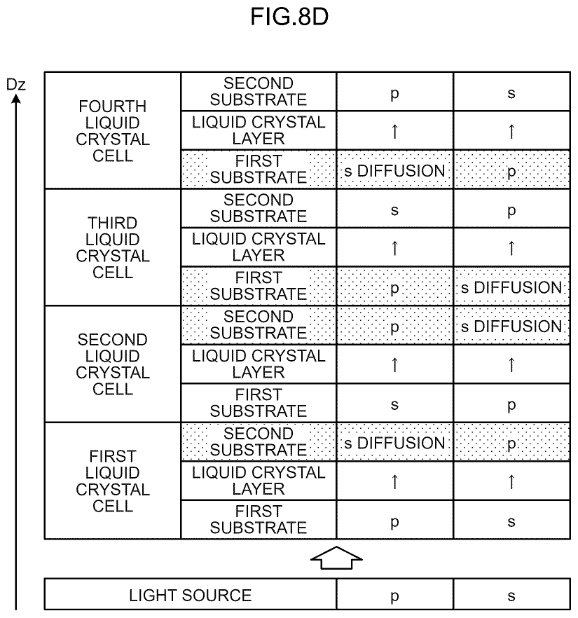

A mechanism for changing the shape of light by using the liquid crystal cells 2 (the first liquid crystal cell 2_1, the second liquid crystal cell 2_2, the third liquid crystal cell 2_3, and the fourth liquid crystal cell 2_4) will be described below. FIG. 7 is a multilayered structure diagram of the optical element 100 according to the embodiment. FIGS. 8A, 8B, 8C, and 8D are conceptual diagrams for description of change in shape of light by the optical element 100 according to the embodiment. FIGS. 8A, 8B, 8C, and 8D illustrate examples in which potential difference is generated between the drive electrodes of hatched substrates of the liquid crystal cells 2.

As illustrated in FIG. 7, the optical element 100 is provided on the optical axis of the light source 4, which is illustrated with a dashed and single-dotted line, and as described above, the first liquid crystal cell 2_1, the second liquid crystal cell 2_2, the third liquid crystal cell 2_3, and the fourth liquid crystal cell 2_4 are sequentially stacked from the light source 4 side (lower side in FIG. 7). The third liquid crystal cell 2_3 and the fourth liquid crystal cell 2_4 are stacked in a state of being rotated by 90° relative to the first liquid crystal cell 2_1 and the second liquid crystal cell 2_2.

In each liquid crystal cell 2, the alignment direction of the alignment film on the first substrate 5 side and the second substrate 6 side intersect each other as illustrated in FIGS. 6A and 6B. Accordingly, from the first substrate 5 side toward the second substrate 6 side, the orientation of the liquid crystal molecules in the liquid crystal layer 8 gradually changes from the Dx direction to the Dy direction (or from the Dy direction to the Dx direction), and the polarized light component of transmitted light rotates along with the change. Specifically, in the liquid crystal cell 2, the polarized light component, which is a p-polarized light component on the first substrate 5 side, changes to an s-polarized light component as distance from the second substrate 6 decreases, and the polarized light component, which is an s-polarized light component on the first substrate 5 side, changes to a p-polarized light component as distance from the second substrate 6 decreases. This rotation of the polarized light component may be referred to as optical rotation.

FIG. 8A illustrates a state in which no potential is generated between adjacent electrodes in each liquid crystal cell 2. In this case, only optical rotation occurs in each liquid crystal cell 2 and no polarized light component is diffused.

As illustrated in FIG. 8B, for example, when potential difference is generated between the drive electrodes 10a and 10b on the first substrate 5 in the first liquid crystal cell 2_1 to induce a horizontal electric field, the liquid crystal molecules between the electrodes are aligned in a circular arc shape, and thus, refractive index distribution is formed in the Dx direction in the liquid crystal layer 8. As light from the light source 4 is transmitted in this state, the above-described refractive index distribution acts on the polarized light component (in FIG. 8B, p-polarized light component) parallel to the Dx direction, and therefore, the p-polarized light component diffuses in the Dx direction.

In addition, when potential difference is generated between the drive electrodes 13a and 13b on the second substrate 6 side in the first liquid crystal cell 2_1, refractive index distribution is formed in the Dy direction on the second substrate 6 side, and accordingly, the s-polarized light component diffuses in the Dy direction on the second substrate 6 side. Specifically, the polarized light component having changed from a p-polarized light component to an s-polarized light component during passing through the liquid crystal layer 8 in the first liquid crystal cell 2_1 diffuses in the Dy direction as well. However, the s-polarized light component at incidence on the first liquid crystal cell 2_1 optically rotates during passing through the liquid crystal layer 8 but intersects each refractive index distribution, and accordingly, only optically rotates without diffusing and passes through the first liquid crystal cell 2_1.

The s-polarized light component at incidence on the first liquid crystal cell 2_1 changes to a p-polarized light component after passing through the first liquid crystal cell 2_1, and the second liquid crystal cell 2_2 acts on this p-polarized light component. Specifically, as illustrated in FIGS. 8A and 8B, the first liquid crystal cell 2_1 acts on the p-polarized light component of light incident on the optical element 100, and the second liquid crystal cell 2_2 acts on the s-polarized light component thereof. Since the third liquid crystal cell 2_3 and the fourth liquid crystal cell 2_4 are provided with rotation by 90° relative to the first liquid crystal cell 2_1 and the second liquid crystal cell 2_2, polarized light components on which they act are switched by 90°. Specifically, the third liquid crystal cell 2_3 acts on the s-polarized light component at incidence on the optical element 100, and the fourth liquid crystal cell 2_4 acts on the p-polarized light component at incidence on the optical element 100.

As illustrated in FIG. 8C, in the optical element, it is possible to act on the p-polarized light component by providing potential difference between drive electrodes extending in the Dy direction in each liquid crystal cell 2 (between the drive electrodes 10a and 10b of the first substrate 5 in the first liquid crystal cell 2_1 and the second liquid crystal cell 2_2 and between the drive electrodes 13a and 13b of the second substrate 6 in the third liquid crystal cell 2_3 and the fourth liquid crystal cell 2_4), thereby increasing the shape of light mainly in the Dx direction. This effect may be referred to as horizontal diffusion.

As illustrated in FIG. 8D, it is possible to act on the s-polarized light component by providing potential difference between drive electrodes extending in the Dx direction in each liquid crystal cell 2 (between the drive electrodes 13a and 13b of the second substrate 6 in the first liquid crystal cell 2_1 and the second liquid crystal cell 2_2 and between the drive electrodes 10a and 10b of the first substrate 5 in the third liquid crystal cell 2_3 and the fourth liquid crystal cell 2_4), thereby increasing the shape of light mainly in the Dy direction. This effect may be referred to as vertical diffusion.

The diffusion degree of light in each direction depends on the potential difference between the drive electrodes 10a and 10b (or between the drive electrodes 13a and 13b) adjacent to each other. The spread of light in the direction is maximum (100%) in a case where the potential difference between the drive electrodes 10a and 10b (or between the drive electrodes 13a and 13b) is maximum potential difference (for example, 30 V) defined in advance, and no spread of light (0%) occurs in the direction in a case where no potential difference is generated. Alternatively, the spread of light in the direction is 50% in a case where the potential difference between the drive electrodes 10a and 10b (or between the drive electrodes 13a and 13b) is 50% (for example, 15 V) of the above-described maximum potential difference. In a case where the relation between voltage difference and light spread is not linear, it is possible to set another potential difference instead of 15 V.

In each liquid crystal cell 2, the interval (also referred to as a cell gap) between its substrates (between the first substrate 5 and the second substrate 6) is large and is 10 μm to 50 μm approximately, more preferably at 15 μm to 35 μm approximately, and thus, influence of an electric field formed in one of the substrates on the other substrate side is reduced as much as possible. Drive voltage that generates potential difference between the drive electrodes 10a and 10b (or between the drive electrodes 13a and 13b) adjacent to each other is what is called an alternating-current square wave, thereby preventing burn-in of the liquid crystal molecules.

The alignment directions of the alignment films, the extending directions of the drive electrodes on the substrates, and the angle between them may be modified as appropriate for the entire optical element 100 or each liquid crystal cell 2 in accordance with the characteristics of liquid crystals to be employed and optical characteristics to be intentionally obtained.

In the present embodiment, description is made on the configuration of the optical element 100 in which the four liquid crystal cells of the first liquid crystal cell 2_1, the second liquid crystal cell 2_2, the third liquid crystal cell 2_3, and the fourth liquid crystal cell 2_4 are stacked, but the optical element 100 is not limited to this configuration and may employ, for example, a configuration in which two or three liquid crystal cells 2 are stacked or a configuration in which a plurality of liquid crystal cells 2, five or more liquid crystal cells 2, are stacked.

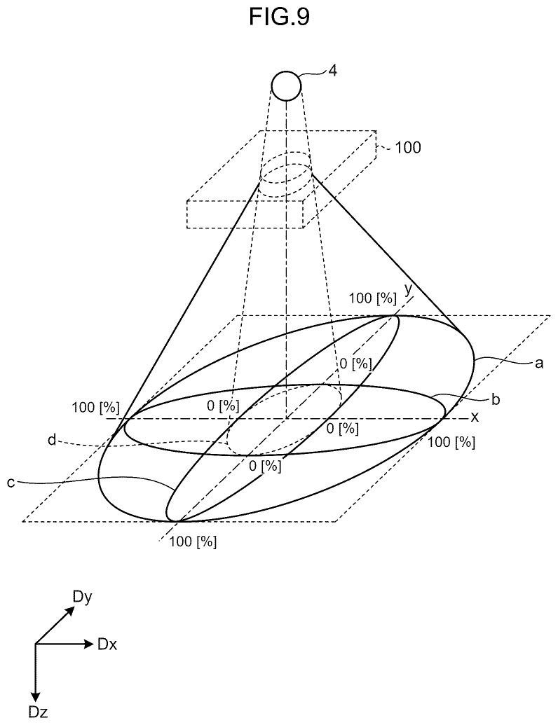

In the present disclosure, in the illumination device 1 with the above-described configuration, light incident on the optical element from the light source 4 is controlled in the two directions of the Dx direction (direction of horizontal diffusion) and the Dy direction (direction of vertical diffusion) by controlling drive voltage of each liquid crystal cell 2. The above-described vertical diffusion and horizontal diffusion may be collectively referred to as light diffusion. Accordingly, the shape of light emitted from the optical element is changed. The shape of light is a light shape that appears on a plane parallel to an emission surface of the optical element, and this may be referred to as a light distribution shape. Hereinafter, control of the light diffusion degree in the present disclosure will be described below with reference to FIG. 9.

FIG. 9 is a conceptual diagram for conceptually describing control of the light diffusion degree of the illumination device 1 according to the embodiment. FIG. 9 illustrates an irradiation area of light on a virtual plane xy orthogonal to the Dz direction. The outline of the actual irradiation area is slightly unclear depending on the distance from the light source 4, a light diffraction phenomenon, and the like.

As described above, the drive voltage is supplied to the drive electrodes 10 and 13 of each liquid crystal cell 2 of the optical element 100 provided on the optical axis of the light source 4, whereby the alignment direction of the liquid crystal molecules 17 in the liquid crystal layer 8 is controlled. Thus, the light distribution shape of light emitted from the optical element 100 is controlled.

Specifically, for example, the light distribution shape in the Dx direction changes with the drive voltage applied to the drive electrodes 10 or drive electrodes 13 extending in the Dy direction in each liquid crystal cell 2 as described above (horizontal diffusion). The light distribution shape in the Dy direction changes with the drive voltage applied to the drive electrodes 10 or drive electrodes 13 extending in the Dx direction in the first to fourth liquid crystal cells (vertical diffusion).

In the present disclosure, the minimum diffusion degrees of the horizontal diffusion and the vertical diffusion are 0% and the maximum diffusion degrees thereof are 100%. More specifically, in a case where the horizontal diffusion degree is 0%, drive electrodes (for example, the drive electrodes 10 extending in the Dy direction on the first substrate 5 in the first liquid crystal cell 2_1) functioning to expand the light distribution state in the Dx direction do not act on the refractive index distribution of the liquid crystal layer 8. In this case, no potential difference is present between the adjacent drive electrodes 10a and 10b or no potential is supplied to the electrodes. On the other hand, in a case where the horizontal diffusion degree is 100%, drive electrodes (for example, the drive electrodes 10 extending in the Dy direction on the first substrate 5 in the first liquid crystal cell 2_1) functioning to expand the light distribution state in the Dx direction maximally act on the refractive index distribution of the liquid crystal layer 8. In this case, the potential difference between the adjacent drive electrodes 10a and 10b is set to the maximum potential difference (for example, 30 V) in the optical element 100. In a case where the horizontal diffusion degree is larger than 0% and smaller than 100%, potential adjusted such that the potential difference between the adjacent drive electrodes 10a and 10b is larger than 0 V and smaller than the maximum potential difference (for example, 30 V) is applied to the electrodes. The same applies to the vertical diffusion.

Outline “a” illustrated in FIG. 9 exemplarily indicates the irradiation area on the virtual plane xy in a case where the horizontal diffusion degree and the vertical diffusion degree are both 100%. Outline “b” illustrated in FIG. 9 exemplarily indicates the irradiation area on the virtual plane xy in a case where the horizontal diffusion degree is 100% and the vertical diffusion degree is 0%. Outline “c” illustrated in FIG. 9 exemplarily indicates the irradiation area in a case where the horizontal diffusion degree is 0% and the vertical diffusion degree is 100%. Outline “d” illustrated in FIG. 9 exemplarily indicates the irradiation area on the virtual plane xy in a case where the horizontal diffusion degree and the vertical diffusion degree are both 0%. In other words, outline “d” indicates the light distribution state when light from the light source 4 is emitted without being controlled by the optical element 100 (or simply transmitted through the optical element 100).

In this manner, in the illumination device 1 with the above-described configuration, it is possible to control the horizontal and vertical diffusion degrees of emission light from the optical element 100 by performing drive voltage control of each liquid crystal cell 2. Accordingly, it is possible to change, on the virtual plane xy, the light distribution shape of emission light from the illumination device 1. Hereinafter, control that changes the light distribution shape of light emitted onto the virtual plane xy by adjusting the horizontal and vertical diffusion degrees of emission light from the illumination device 1 is also referred to as “light distribution control”.

In the present disclosure, the illumination device 1 controllable with respect to the light distribution in the two directions of the Dx and Dy directions is exemplarily described, but the controllable parameters of the illumination device 1 are not limited to light distribution (light spread). For example, the illumination device 1 may be configured to be subject to light adjustment control. In this case, the controllable parameters of the illumination device 1 may include light adjustment (brightness).

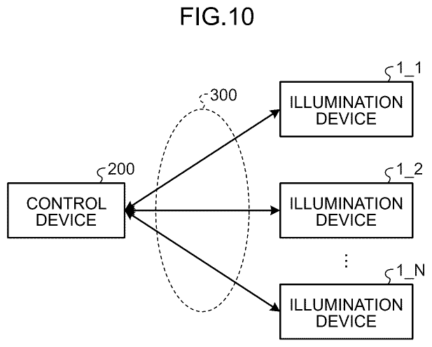

FIG. 10 is a schematic view illustrating an example of the configuration of an illumination system according to the embodiment. The illumination system according to the embodiment includes a plurality of illumination devices 1_1, 1_2, . . . , and 1_N and a control device 200. The control device 200 is, for example, a portable communication terminal device such as a smartphone or a tablet.

Data and various command signals are transmitted bidirectionally between the control device 200 and each of the illumination devices 1_1, 1_2, . . . , and 1_N through a communication means 300. In the present disclosure, the communication means 300 is a wireless communication means of, for example, Bluetooth (registered trademark) or WiFi (registered trademark). Wireless communication may be performed between the control device 200 and each of the illumination devices 1_1, 1_2, . . . , and 1_N through, for example, a predetermined network such as a mobile communication network. Alternatively, each of the illumination devices 1_1, 1_2, . . . , and 1_N and the control device 200 may be coupled in a wired manner to perform wired communication therebetween.

In the example illustrated in FIG. 10, N (N is a natural number equal to or larger than one) illumination devices 1_n (n is a natural number of 1 to N) are exemplified, but the present disclosure is not limited by the number of illumination devices 1. Furthermore, in the present disclosure, an aspect in which the diffusion degree of each illumination device 1 is controlled as a setting parameter of the illumination device 1 will be described below, but the setting parameter is not limited to the diffusion degree. Examples of setting parameters of the illumination device 1 may include the light quantity and color temperature of the illumination device 1.

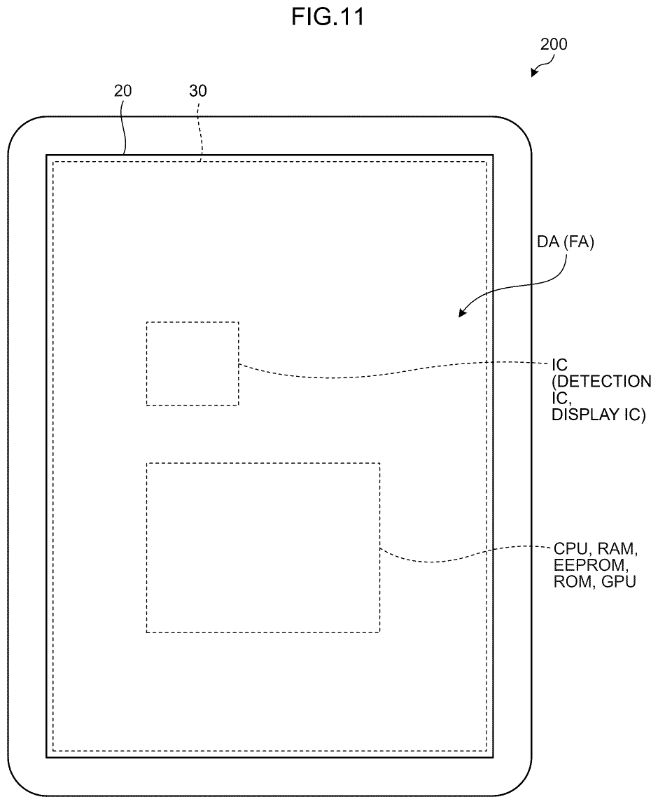

FIG. 11 is an exterior diagram illustrating an example of the control device 200 according to the embodiment. The control device 200 is a display device (touch screen) with a touch detection function in which a display panel 20 and a touch sensor 30 are integrated. The control device 200 includes, as internal constituent components, for example, various ICs such as a detection IC and a display IC, and a central processing unit (CPU), a random access memory (RAN), an electrically erasable programmable read only memory (EEPROM), a read only memory (ROM), and a graphics processing unit (GPU) of a smartphone, a tablet, or the like constituting the control device 200.

The display panel 20 is what is called an in-cell or hybrid device in which the touch sensor 30 is built and integrated. Building and integrating the touch sensor 30 in the display panel 20 includes, for example, sharing some members such as substrates and electrodes used as the display panel 20 and some members such as substrates and electrodes used as the touch sensor 30. The display panel 20 may be what is called an on-cell type device in which the touch sensor 30 is mounted on a display device.

The display panel 20 is, for example, a liquid crystal display panel including a liquid crystal display element. The display panel 20 is not limited thereto but may be, for example, an organic EL display panel (organic light emitting diode (OLED)) or an inorganic EL display panel (micro LED or mini LED).

The touch sensor 30 is, for example, a capacitive touch sensor. The touch sensor 30 is not limited thereto but may be, for example, a touch sensor of a resistance film scheme or a touch sensor of an ultrasonic wave scheme or an optical scheme.

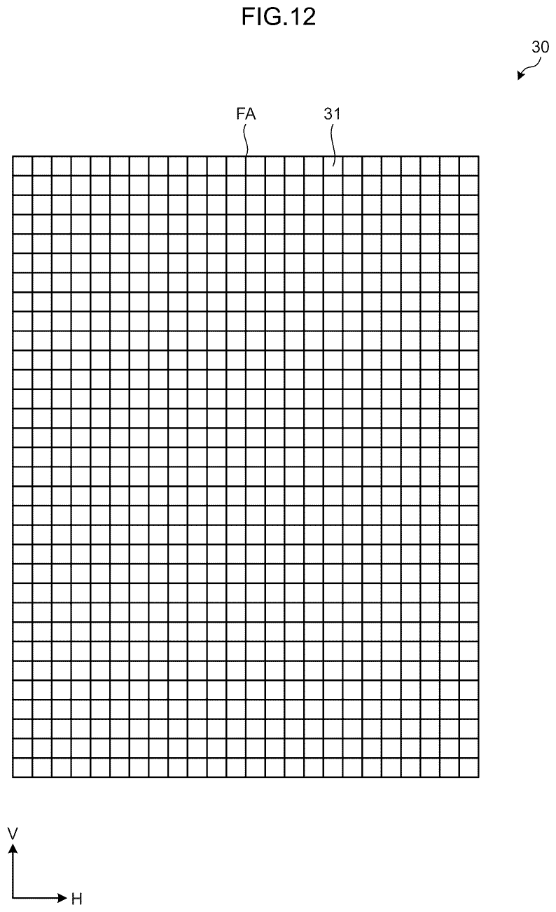

FIG. 12 is a conceptual diagram illustrating an example of a detection region of the touch sensor 30. A plurality of detection elements 31 are provided in a detection region FA of the touch sensor 30. The detection elements 31 in the detection region FA of the touch sensor 30 are arranged in an X direction and a Y direction orthogonal to the X direction and provided in a matrix of a row-column configuration. In other words, the touch sensor 30 has the detection region FA overlapping the detection elements 31 arranged in the X direction and the Y direction.

The following describes the configuration and operation of the control device 200 configured to control the light diffusion degree of the illumination device 1 and the configuration and operation of the illumination device 1.

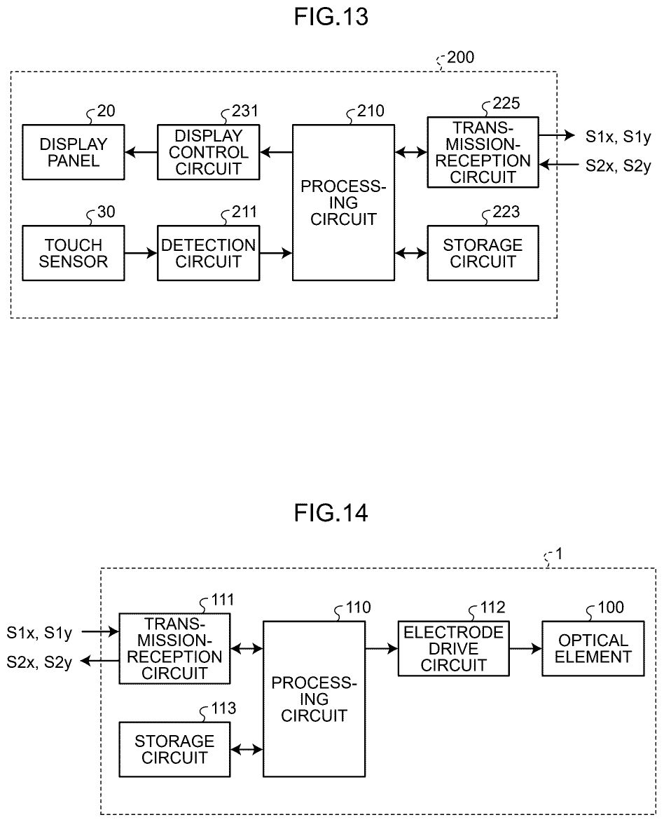

FIG. 13 is a diagram illustrating an example of a control block configuration of the control device 200. Here, a control block configuration for executing each processing to be described later will be first described below.

As illustrated in FIG. 13, the control device 200 includes the display panel 20, the touch sensor 30, a processing circuit 210, a detection circuit 211, a storage circuit 223, a transmission-reception circuit 225, and a display control circuit 231. The detection circuit 211 is configured with, for example, a detection IC. Alternatively, the detection circuit 211 and the display control circuit 231 may be mounted as one display IC on the display panel 20 or on an FPC coupled to the display panel 20. The processing circuit 210 and the storage circuit 223 are each configured with, for example, the CPU, RAM, EEPROM, and ROM of a smartphone, a tablet, or the like constituting the control device 200. The display control circuit 231 may be a display IC mounted on the display panel 20 as described above, and moreover, may include, for example, the GPU of a smartphone, a tablet, or the like constituting the control device 200. The transmission-reception circuit 225 is configured with, for example, a wireless communication module of a smartphone, a tablet, or the like constituting the control device 200.

The detection circuit 211 is a circuit that detects a touch on the touch sensor 30 based on a detection signal output from each detection element 31 of the touch sensor 30.

The processing circuit 210 senses a touch on an illumination control application screen based on a touch detection position in the detection circuit 211 and executes operation control of an illumination control application to be described later. The processing circuit 210 is a component achieved by, for example, the CPU of a smartphone, a tablet, or the like constituting the control device 200.

The storage circuit 223 is configured with, for example, the RAM, EEPROM, and ROM of a smartphone, a tablet, or the like constituting the control device 200. Data necessary for operation of the illumination control application to be described later, such as various parameter values and various setting values, is stored in the storage circuit 223. The data necessary for operation of the illumination control application will be described later.

The transmission-reception circuit 225 transmits and receives setting information to and from the illumination device 1. Specifically, the transmission-reception circuit 225 receives second setting information (horizontal diffusion degree S2x and vertical diffusion degree S2y) transmitted from the illumination device 1 in initial setting processing of the illumination control application to be described later. In addition, the transmission-reception circuit 225 transmits a horizontal diffusion degree Sx and a vertical diffusion degree Sy, which are set in illumination control processing to be described later, to the illumination device 1 as first setting information (horizontal diffusion degree S1x and vertical diffusion degree S1y).

The display control circuit 231 performs display control of the display panel 20 in accordance with operation control of the illumination control application to be described later.

FIG. 14 is a diagram illustrating an example of a control block configuration of the illumination device 1 according to the embodiment. As illustrated in FIG. 14, the illumination device 1 includes a processing circuit 110, a transmission-reception circuit 111, an electrode drive circuit 112, and a storage circuit 113 as control blocks for controlling the optical element 100 described above. The processing circuit 110 is configured with, for example, a microcomputer. The storage circuit 113 is configured with, for example, a RAM, an EEPROM, or a ROM.

The transmission-reception circuit 111 transmits and receives the setting information to and from the control device 200. Specifically, the transmission-reception circuit 111 receives the first setting information transmitted from the control device 200 at activation of the illumination device 1. The processing circuit 110 stores the first setting information received by the transmission-reception circuit 111 in the storage circuit 113 as the second setting information. In addition, the processing circuit 110 reads the second setting information stored in the storage circuit 113, and the transmission-reception circuit 111 transmits the second setting information read from the storage circuit 113 by the processing circuit 110, to the control device 200.

Moreover, the processing circuit 110 reads the second setting information stored in the storage circuit 113, the electrode drive circuit 112 supplies drive voltage in accordance with the second setting information read by the processing circuit 110, to the drive electrodes 10 and 13 of each liquid crystal cell 2 of the optical element 100.

In the present disclosure, upon activation of the illumination device 1, the illumination device 1 transmits the second setting information stored in the storage circuit 113 to the control device 200 and stores, in the storage circuit 113 as the new second setting information (horizontal diffusion degree S2x and vertical diffusion degree S2y), the first setting information (horizontal diffusion degree S1x and vertical diffusion degree S1y) transmitted from the control device 200 in the illumination control processing to be described later. In other words, the first setting information is transmitted from the control device 200 to the illumination device 1, whereby the second setting information is updated to the first setting information.

Processing of the control device 200 in the present disclosure is executed by application software (hereinafter also referred to as “illumination control application”) operating on the control device 200. The following describes specific examples of processing of the illumination control application that operates on the control device 200 and the display aspect of the display panel 20 in detail.

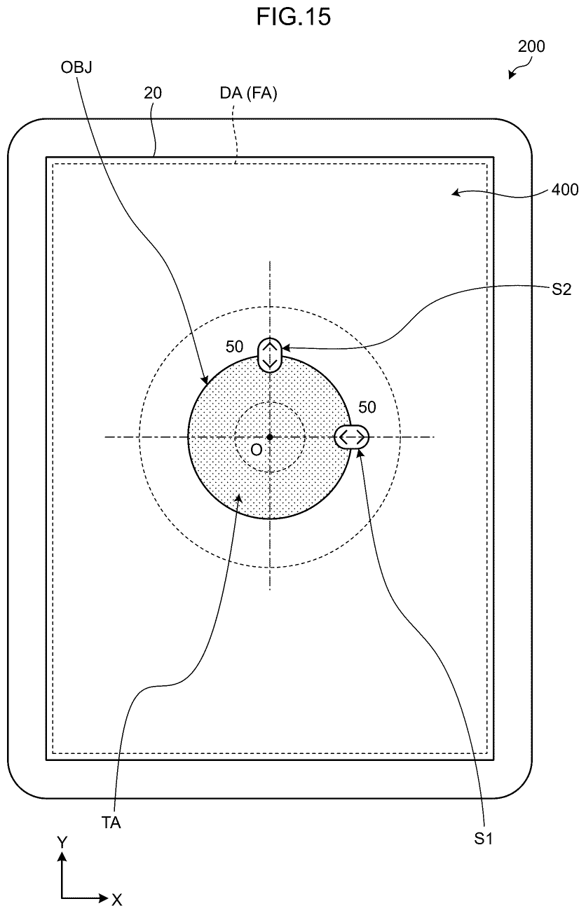

FIG. 15 is a conceptual diagram illustrating an example of the display aspect of an illumination control application screen 400.

In description of the present disclosure, it is assumed that the illumination control application is installed on the control device 200 in advance.

When the illumination control application is activated, the illumination control application screen 400 illustrated in FIG. 15 is displayed on the display panel 20. The illumination control application screen 400 is an adjustment screen for adjusting the vertical and horizontal diffusion degrees of the illumination device 1 based on the movement amount of the touch detection position in the detection region FA.

On the illumination control application screen 400 illustrated in FIG. 15, the X direction is defined as the Dx direction (first direction) in light diffusion degree control of the illumination device 1, and the Y direction is defined as the Dy direction (second direction) in light diffusion degree control of the illumination device 1. An XY plane with an origin O(0, 0) at a predetermined position in a display region DA is defined on the illumination control application screen 400.

The display panel 20 is provided with the display region DA overlapping the detection region FA of the touch sensor 30 in plan view. In the example illustrated in FIG. 15, a light distribution shape object OBJ having a center point at the origin O(0, 0) of the XY plane on the illumination control application screen 400 is displayed, and a first slider S1 for setting the horizontal diffusion degree of the illumination device 1 and a second slider S2 for setting the vertical diffusion degree of the illumination device 1 are disposed on the outline of the light distribution shape object OBJ.

The light distribution shape object OBJ is a pictorial image on the illumination control application screen 400, corresponding to the light distribution state of light emitted from the illumination device 1. In other words, the shape and size of the light distribution shape object OBJ are a pictorial image on the illumination control application screen 400, simulating the irradiation area (refer to FIG. 9) of light from the illumination device 1.

In the configuration according to the embodiment, the shape of the light distribution shape object OBJ on the illumination control application screen 400 changes into a circular or elliptical shape in accordance with the horizontal diffusion degree and the vertical diffusion degree. In the example illustrated in FIG. 15, the horizontal diffusion degree of the illumination device 1 is 50%, the vertical diffusion degree is 50%, and the shape of the light distribution shape object OBJ is a circular shape.

As illustrated in FIG. 9, in the illumination device 1 as a control target in the present disclosure, a predetermined substantially circular area corresponding to outline “d” is irradiated with light even in a case where the horizontal and vertical diffusion degrees of the illumination device 1 are both 0%. In the present disclosure, the light distribution shape object OBJ in a small circular shape overlapping the inner dashed line illustrated in FIG. 15 is displayed in a case where the horizontal and vertical diffusion degrees are both 0%. The light distribution shape object OBJ in a large circular shape overlapping the outer dashed line illustrated in FIG. 15, which corresponds to outline “a” in FIG. 9, is displayed in a case where the horizontal and vertical diffusion degrees of the illumination device 1 are both 100%.

The first slider S1 and the second slider S2 are, for example, pictorial images displayed on the illumination control application screen 400, and a user can touch and move them with their finger (drag operation).

The shape of the light distribution shape object OBJ can be changed by moving the first slider S1 in the X direction. Simultaneously, the horizontal diffusion degree (diffusion degree in the Dx direction) of the illumination device 1 is controlled. The shape of the light distribution shape object OBJ can be changed by moving the second slider S2 in the Y direction. Simultaneously, the vertical diffusion degree (diffusion degree in the Dy direction) of the illumination device 1 is controlled.

The first slider S1 can be moved in the X direction between the position on the outline of the light distribution shape object OBJ when the horizontal diffusion degree is 0% and the position on the outline of the light distribution shape object OBJ when the horizontal diffusion degree is 100%.

When the user touches a region inside the outline of the first slider S1, the first slider S1 is selected as a drag operation target, and the first slider S1 can be moved. When a finger of the user is released from the screen or when the finger remains on the screen but shifts in the Y direction such that the touch detection position moves out of the region inside the outline of the first slider S1, the first slider S1 is no longer a drag operation target and does not move.

The second slider S2 can be moved in the Y direction between the position on the outline of the light distribution shape object OBJ when the vertical diffusion degree is 0% and the position on the outline of the light distribution shape object OBJ when the vertical diffusion degree is 100%.

When the user touches a region inside the outline of the second slider S2, the second slider S2 is selected as a drag operation target, and the second slider S2 can be moved. When a finger of the user is released from the screen or when the finger remains on the screen but shifts in the X direction such that the touch detection position moves out of the region inside the outline of the second slider S2, the second slider S2 is no longer a drag operation target and does not move.

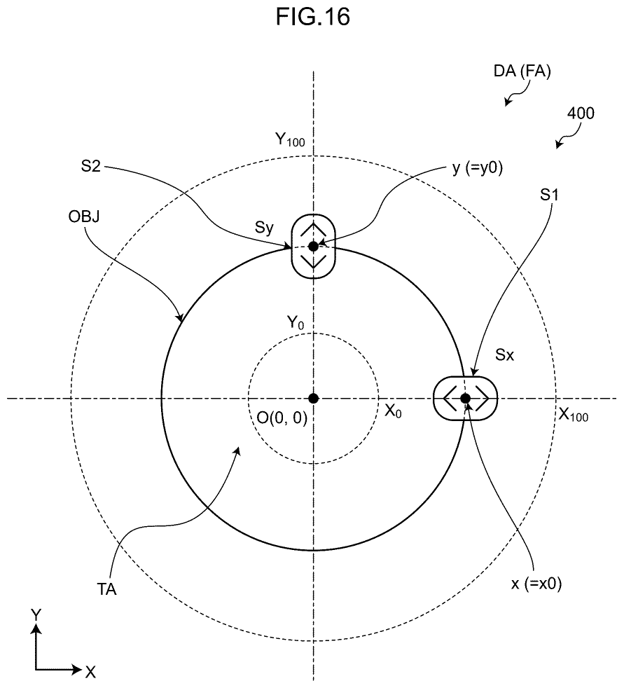

FIG. 16 is a diagram for description of the relation between the position on the illumination control application and the diffusion degree. In the present disclosure, to facilitate description, the position (coordinate) in the display region DA of the display panel 20 and the position (coordinate) on the detection region FA of the touch sensor 30 are assumed to be equivalent.

On the illumination control application screen 400 of the control device 200, the horizontal diffusion degree of the illumination device 1 can be set based on a position x of an intersection point between the X axis of the XY plane and the outline of the light distribution shape object OBJ.

In the present disclosure, the first slider S1 has a center point at the position x of the intersection point between the X axis and the outline of the light distribution shape object OBJ. In other words, a position x0 of the first slider S1 on the display region DA coincides with the position x of the intersection point between the X axis and the outline of the light distribution shape object OBJ. In the present disclosure, the touch detection position in the X direction while the first slider S1 is touched is the position x0 of the first slider S1 on the display region DA. Accordingly, the horizontal diffusion degree Sx of the illumination device 1 can be adjusted by dragging the first slider S1 in the X direction. In FIG. 16, “Sx” near the first slider S1 indicates the horizontal diffusion degree of the illumination device 1 corresponding to the position x0 of the first slider S1 on the display region DA.

The relation between the position x0 of the first slider S1 on the display region DA and the horizontal diffusion degree Sx can be expressed as described below.

A reference movement amount Px in the X direction on the XY plane in a case where the amount of one step change of the horizontal diffusion degree of the illumination device 1 is 1% is expressed by Expression (1) below, where X₁₀₀ represents the intersection point of the X axis and the outline of the light distribution shape object OBJ in a case where the horizontal diffusion degree Sx is 100%, and Xo represents the intersection point of the X axis and the outline of the light distribution shape object OBJ in a case where the horizontal diffusion degree Sx is 0%.

$$Px = ( {X}_{100} - {X}_{0} ) / 100 \qquad ( 1 )$$

The relation between the horizontal diffusion degree Sx and the position x0 of the first slider S1 on the display region DA on the XY plane is expressed by Expressions (2) and (3) below by using Expression (1) above.

$$Sx = ( x 0 - {X}_{0} ) / Px \qquad ( 2 )$$

$$x 0 = Sx \times Px + {X}_{0} \qquad ( 3 )$$

With the correspondence relation between the horizontal diffusion degree Sx and the position x0 of the first slider S1 on the display region DA, the horizontal diffusion degree Sx can be adjusted depending on the movement amount of the first slider S1 in the X direction on the display region DA.

In addition, the vertical diffusion degree of the illumination device 1 on the illumination control application screen 400 can be set based on a position y of an intersection point between the Y axis of the XY plane and the outline of the light distribution shape object OBJ.

In the present disclosure, the second slider S2 has a center point at the position y of the intersection point between the Y axis and the outline of the light distribution shape object OBJ. In other words, a position y0 of the second slider S2 on the display region DA coincides with the position y of the intersection point between the Y axis and the outline of the light distribution shape object OBJ. In the present disclosure, the touch detection position in the Y direction while the second slider S2 is touched is the position y0 of the second slider S2 on the display region DA. Accordingly, the vertical diffusion degree Sy of the illumination device 1 can be set by dragging the second slider S2 in the Y direction. In FIG. 16, “Sy” near the second slider S2 indicates the vertical diffusion degree of the illumination device 1 corresponding to the position y0 of the second slider S2 on the display region DA.

The relation between the position y0 of the second slider S2 on the display region DA and the vertical diffusion degree Sy can be expressed as described below.

A reference movement amount Py in the Y direction on the XY plane in a case where the amount of one step change of the vertical diffusion degree of the illumination device 1 is 1% is expressed by Expression (4) below, where Y₁₀₀ represents the intersection point of the Y axis and the outline of the light distribution shape object OBJ in a case where the vertical diffusion degree Sy is 100%, and Y₀ represents the intersection point of the Y axis and the outline of the light distribution shape object OBJ in a case where the vertical diffusion degree Sy is 0%.

$$P y = ( {Y}_{100} - {Y}_{0} ) / 100 \qquad ( 4 )$$

The relation between the vertical diffusion degree Sy and the position y0 of the second slider S2 on the display region DA on the XY plane is expressed by Expressions (5) and (6) below by using Expression (4) above.

$$S y = ( y 0 - {Y}_{0} ) / Py \qquad ( 5 )$$

$$y 0 = Sy \times Py + {Y}_{0} \qquad ( 6 )$$

With the correspondence relation between the vertical diffusion degree Sy and the position y0 of the second slider S2 on the display region DA on the XY plane, the vertical diffusion degree Sy can be adjusted depending on the movement amount of the second slider S2 in the Y direction on the display region DA.

In the present disclosure, when a touch on the first slider S1 on the illumination control application screen 400 described above is detected in the illumination control processing to be described later, the control device 200 transitions to horizontal diffusion degree adjustment processing.

When a touch on the second slider S2 on the illumination control application screen 400 described above is detected in the illumination control processing to be described later, the control device 200 transitions to vertical diffusion degree adjustment processing.

In the present disclosure, in addition to individual adjustment processing of the horizontal diffusion degree or the vertical diffusion degree by a touch on the first slider S1 or the second slider S2, the horizontal diffusion degree and the vertical diffusion degree are simultaneously changed by detecting two consecutive touches (hereinafter also referred to as “double tap”) in a predetermined determination region provided on the detection region FA within a predetermined time or continuation of a touch (hereinafter also referred to as “long tap”) in the determination region for a predetermined time or longer. Accordingly, the irradiation area of light from the illumination device 1 can be intuitively enlarged or reduced.

FIGS. 15 and 16 illustrate an example in which the inner region of the light distribution shape object OBJ is defined as a determination region TA. The determination region TA illustrated in FIGS. 15 and 16 is exemplary and not limited to the inner region of the light distribution shape object OBJ. The determination region TA may be, for example, an arbitrary region on the illumination control application screen 400 except for at least the first slider S1 and the second slider S2.

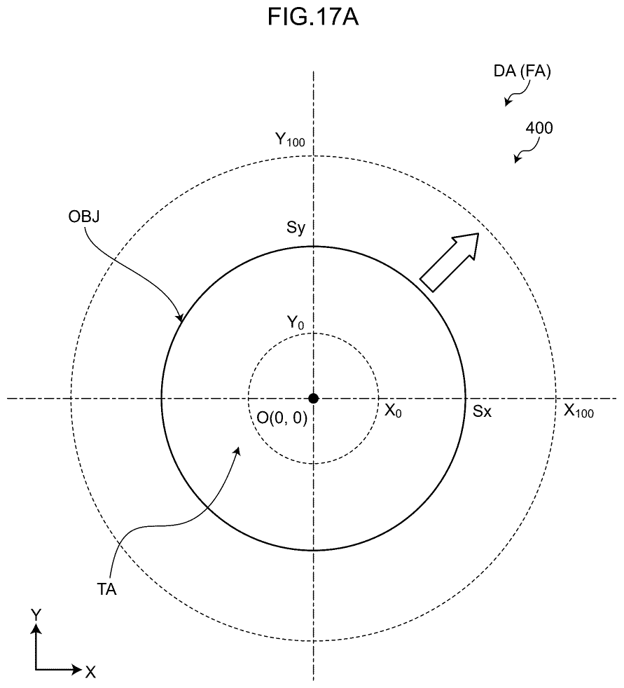

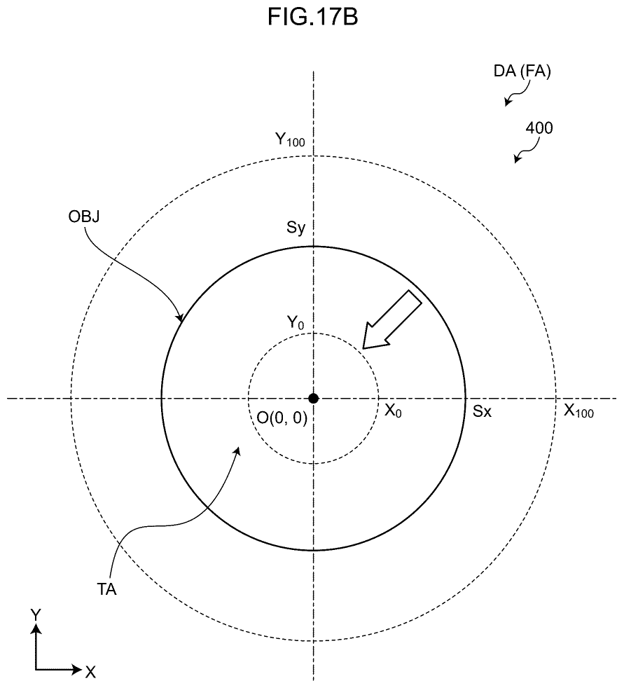

FIG. 17A is a diagram illustrating an example of a shape change of the light distribution shape object OBJ in a case where the determination region TA is double-tapped on the illumination control application screen 400. FIG. 17B is a diagram illustrating an example of a shape change of the light distribution shape object OBJ in a case where the determination region TA is long-tapped on the illumination control application screen 400. In FIGS. 17A and 17B, the first slider S1 and the second slider S2 are omitted. In the examples illustrated in FIGS. 17A and 17B, the shape of the light distribution shape object OBJ is a substantially circular shape, but the shape of the light distribution shape object OBJ becomes an elliptical shape depending on the horizontal diffusion degree Sx and the vertical diffusion degree Sy.

In the example illustrated in FIG. 17A, the horizontal diffusion degree and the vertical diffusion degree are increased at identical or substantially identical ratios in a case where the determination region TA is double-tapped. Accordingly, the light distribution shape object OBJ is enlarged in the direction of arrow while the shape is maintained. In the example illustrated in FIG. 17B, the horizontal diffusion degree and the vertical diffusion degree are decreased at identical or substantially identical ratios in a case where the determination region TA is long-tapped. Accordingly, the light distribution shape object OBJ is reduced in the direction of arrow while the shape is maintained. In other words, the irradiation area of light from the illumination device 1 is enlarged when the determination region TA is double-tapped on the illumination control application screen 400, and the irradiation area of light from the illumination device 1 is reduced when the determination region TA is long-tapped on the illumination control application screen 400.

Although the present embodiment describes, as an example, the aspect in which the horizontal diffusion degree and the vertical diffusion degree are increased at identical or substantially identical ratios when the determination region TA is double-tapped, and the horizontal diffusion degree and the vertical diffusion degree are decreased at identical or substantially identical ratios when the determination region TA is long-tapped, the present disclosure is not limited thereto. Specifically, for example, an aspect is applicable in which the horizontal diffusion degree and the vertical diffusion degree are increased at identical or substantially identical ratios when the determination region TA is long-tapped, and the horizontal diffusion degree and the vertical diffusion degree are decreased at identical or substantially identical ratios when the determination region TA is double-tapped.

Touch operations to be sensed in the determination region TA are not limited to a double tap and a long tap. For example, an aspect is applicable in which the determination region TA for detecting a predetermined touch operation is provided in the detection region FA; a first touch operation defined by the number of touches, the duration of a touch in the determination region TA, or both, and a second touch operation different from the first touch operation are set in advance; the horizontal diffusion degree and the vertical diffusion degree are increased at identical or substantially identical ratios when the first touch operation is detected; and the horizontal diffusion degree and the vertical diffusion degree are decreased at identical or substantially identical ratios when the second touch operation is detected. Moreover, the touch operations (the first touch operation and the second touch operation) to be detected in the determination region TA may include, for example, a multi-touch gesture involving touching the determination region TA with a plurality of fingers.

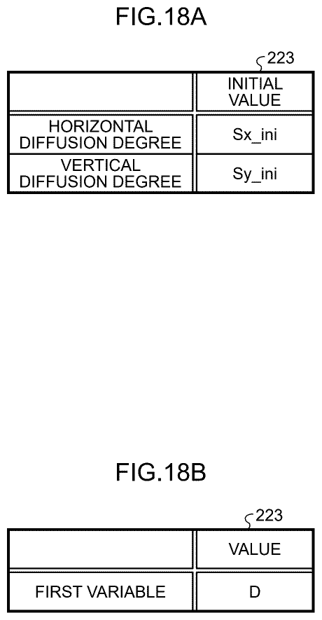

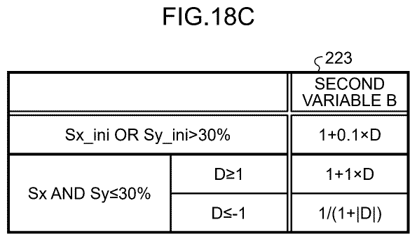

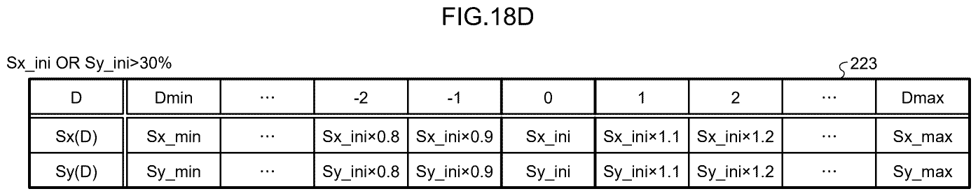

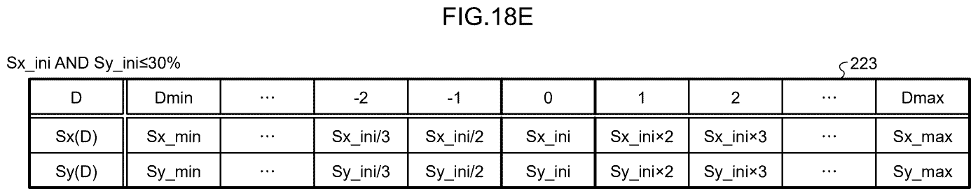

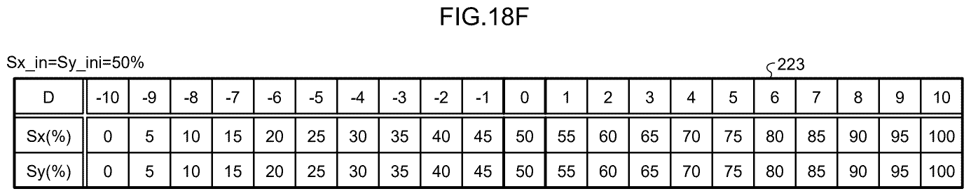

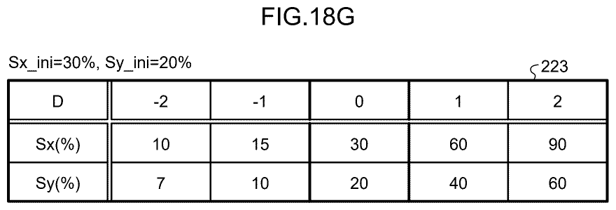

FIGS. 18A, 18B, 18C, 18D, and 18E are diagrams illustrating examples of data used in the illumination control application. The data illustrated in FIGS. 18A, 18B, 18C, 18D, and 18E is stored in the storage circuit 223 of the control device 200.

The control device 200 stores the horizontal diffusion degree S2x and the vertical diffusion degree S2y (second setting information) on the illumination device 1 acquired in the initial setting processing of the illumination control application to be described later in the storage circuit 223 as a horizontal diffusion degree initial value Sx_ini and a vertical diffusion degree initial value Sy_ini, respectively. The control device 200 also stores the horizontal diffusion degree Sx set by the horizontal diffusion degree adjustment processing to be described later in the storage circuit 223 as the horizontal diffusion degree initial value Sx_ini. The control device 200 also stores the vertical diffusion degree Sy set by the vertical diffusion degree adjustment processing to be described later in the storage circuit 223 as the vertical diffusion degree initial value Sy_ini.

A first variable D is set to D=0 for the horizontal diffusion degree initial value Sx_ini and the vertical diffusion degree initial value Sy_ini. In enlargement processing and reduction processing to be described later, the first variable D is incremented when the horizontal diffusion degree Sx and the vertical diffusion degree Sy are increased by one step, and is decremented when the horizontal diffusion degree Sx and the vertical diffusion degree Sy are decreased by one step. The first variable D is updated as appropriate in the illumination control processing to be described later.

A second variable B defines a magnification for the horizontal diffusion degree initial value Sx_ini and the vertical diffusion degree initial value Sy_ini and changes with the first variable D. The second variable B is set and stored in the storage circuit 223 in advance.

In the present disclosure, the second variable B differs between a case where at least one of the horizontal diffusion degree initial value Sx_ini and the vertical diffusion degree initial value Sy_ini exceeds 30% and a case where the horizontal diffusion degree initial value Sx_ini and the vertical diffusion degree initial value Sy_ini are both equal to or lower than 30%.

The second variable B also differs between the case of the first variable D≥1 and the case of the first variable D≤−1 when the horizontal diffusion degree initial value Sx_ini and the vertical diffusion degree initial value Sy_ini are both equal to or lower than 30%.

In the present embodiment, description will be made by using calculation expressions for the second variable B illustrated in FIG. 18C, but the calculation expressions for the second variable B illustrated in FIG. 18C are exemplary and the present disclosure is not limited thereto.

In conversion table generation processing to be described later, the control device 200 generates the conversion table illustrated in FIG. 18D or 18E and stores the generated conversion table in the storage circuit 223. FIG. 18D illustrate a conversion table in a case where at least one of the horizontal diffusion degree initial value Sx_ini and the vertical diffusion degree initial value Sy_ini exceeds 30%, and FIG. 18E illustrates a conversion table in a case where the horizontal diffusion degree initial value Sx_ini and the vertical diffusion degree initial value Sy_ini are both equal to or lower than 30%.

In a case where at least one of the horizontal diffusion degree initial value Sx_ini and the vertical diffusion degree initial value Sy_ini exceeds 30%, the magnification (second variable B) relative to the horizontal diffusion degree initial value Sx_ini and the vertical diffusion degree initial value Sy_ini for the horizontal diffusion degree Sx and the vertical diffusion degree Sy, respectively, increases or decreases by 0.1 for each step of the first variable D as illustrated in FIG. 18D. More specifically, in the region of the first variable D≥1, the magnification (second variable B) relative to the horizontal diffusion degree initial value Sx_ini and the vertical diffusion degree initial value Sy_ini for the horizontal diffusion degree Sx and the vertical diffusion degree Sy, respectively, increases by 0.1 each time the first variable D increases by one. In the region of the first variable D≤−1, the magnification (second variable B) relative to the horizontal diffusion degree initial value Sx_ini and the vertical diffusion degree initial value Sy_ini for the horizontal diffusion degree Sx and the vertical diffusion degree Sy, respectively, decreases by 0.1 each time the first variable D decreases by one.

In a case where the horizontal diffusion degree initial value Sx_ini and the vertical diffusion degree initial value Sy_ini are both equal to or lower than 30%, in the region of the first variable D≥1, the magnification (second variable B) relative to the horizontal diffusion degree initial value Sx_ini and the vertical diffusion degree initial value Sy_ini for the horizontal diffusion degree Sx and the vertical diffusion degree Sy, respectively, becomes 2 times, 3 times, . . . each time the first variable D increases by one as illustrated in FIG. 18E. In the region of the first variable D≤−1, the magnification (second variable B) relative to the horizontal diffusion degree initial value Sx_ini and the vertical diffusion degree initial value Sy_ini for the horizontal diffusion degree Sx and the vertical diffusion degree Sy, respectively, becomes ½ times, ⅓ times, . . . each time the first variable D decreases by one.

FIGS. 18F and 18G are diagrams illustrating specific examples of a conversion table.

FIG. 18F illustrates a conversion table in a case where the horizontal diffusion degree initial value Sx_ini and the vertical diffusion degree initial value Sy_ini are both 50%. In this example, in the entire range of the first variable D, the horizontal diffusion degree Sx and the vertical diffusion degree Sy increase or decrease by 5% for an increase or decrease in the first variable D by one step. In the example illustrated in FIG. 18F, the first variable D=10 corresponding to 100% of both the horizontal diffusion degree Sx and the vertical diffusion degree Sy is set as a maximum value Dmax of the first variable, and the first variable D=−10 corresponding to 0% of both the horizontal diffusion degree Sx and the vertical diffusion degree Sy is set as a minimum value Dmin of the first variable.

FIG. 18G illustrates a conversion table in a case where the horizontal diffusion degree initial value Sx_ini is 30% and the vertical diffusion degree initial value Sy_ini is 20%. In this example, in the region of the first variable D≥1, the horizontal diffusion degree Sx increases by 30% and the vertical diffusion degree Sy increases by 20% for an increase in the first variable D by one step. In the example illustrated in FIG. 18G, the first variable D=2, with which the horizontal diffusion degree Sx remains at 100% or lower, is set as the maximum value Dmax of the first variable since the horizontal diffusion degree Sx exceeds 100% in the case of the first variable D=3.

In the region of the first variable D≤−1, the horizontal diffusion degree Sx is 15% (=30%/2) and the vertical diffusion degree Sy is 10% (=20%/2) in the case of the first variable D=−1, and the horizontal diffusion degree Sx is 10% (=30%/3) and the vertical diffusion degree Sy is 7% (˜20%/3) in the case of the first variable D=−2. Values are rounded to the nearest integer in the conversion table generation processing to be described later. In the example illustrated in FIG. 18G, the first variable D=−2, for which the vertical diffusion degree Sy is lower than 10%, is set as the minimum value Dmin of the first variable.

In the enlargement processing and the reduction processing to be described later, the control device 200 reads the horizontal diffusion degree Sx and the vertical diffusion degree Sy by referring to the conversion table (for example, FIG. 18F or 18G) stored in the storage circuit 223, and transmits the read diffusion degrees to the illumination device 1 as the first setting information (horizontal diffusion degree S1x and vertical diffusion degree S1y). When the first variable D is larger than the maximum value Dmax or smaller than the minimum value Dmin, the enlargement processing or the reduction processing is disabled.

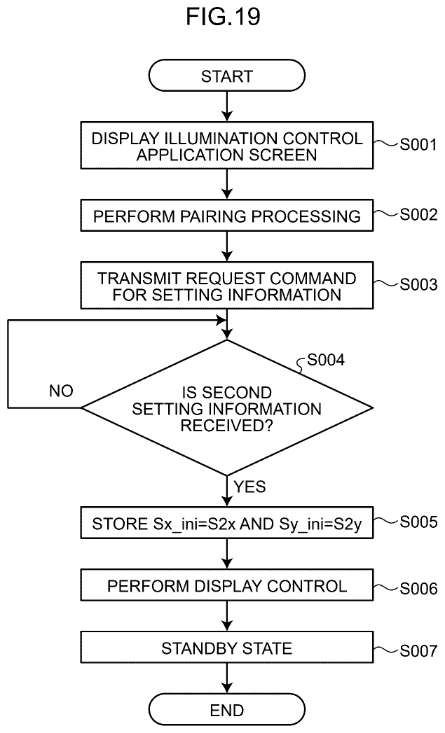

The following describes specific examples of processing by the control device 200 for the illumination device 1 according to the embodiment described above. FIG. 19 is a flowchart illustrating an example of the initial setting processing of the illumination control application.

When the illumination control application is activated on the control device 200, the illumination control application screen 400 illustrated in FIG. 15 is displayed on the display region DA (step S001).

The transmission-reception circuit 225 of the control device 200 executes pairing processing with the illumination device 1 (step S002) and transmits a request command for the second setting information to a control target device (illumination device 1) (step S003).

The processing circuit 110 of the illumination device 1 reads the horizontal diffusion degree S2x and the vertical diffusion degree S2y stored in the storage circuit 113, and the transmission-reception circuit 111 of the illumination device 1 transmits the horizontal diffusion degree S2x and the vertical diffusion degree S2y read by the processing circuit 110 to the control device 200 as the second setting information. In addition, the electrode drive circuit 112 of the illumination device 1 supplies drive voltage corresponding to the horizontal diffusion degree S2x and the vertical diffusion degree S2y read by the processing circuit 110 to the drive electrodes 10 and 13 of each liquid crystal cell 2 of the optical element 100.

The transmission-reception circuit 225 of the control device 200 determines whether the second setting information is received from the illumination device 1 (step S004). If the second setting information is not received from the illumination device 1 (No at step S004), the processing at step S004 is re-executed.

If the transmission-reception circuit 225 receives the second setting information from the illumination device 1 (Yes at step S004), the processing circuit 110 stores the horizontal diffusion degree S2x and the vertical diffusion degree S2y (second setting information) of the illumination device 1 in the storage circuit 223 as the horizontal diffusion degree initial value Sx_ini and the vertical diffusion degree initial value Sy_ini, respectively (step S005). The display control circuit 231 of the control device 200 reflects the horizontal diffusion degree initial value Sx_ini and the vertical diffusion degree initial value Sy_ini to display control on the illumination control application screen 400 (step S006).

When the processing up to step S006 ends, the process transitions to a standby state (step S007), thereby ending the initial setting processing.

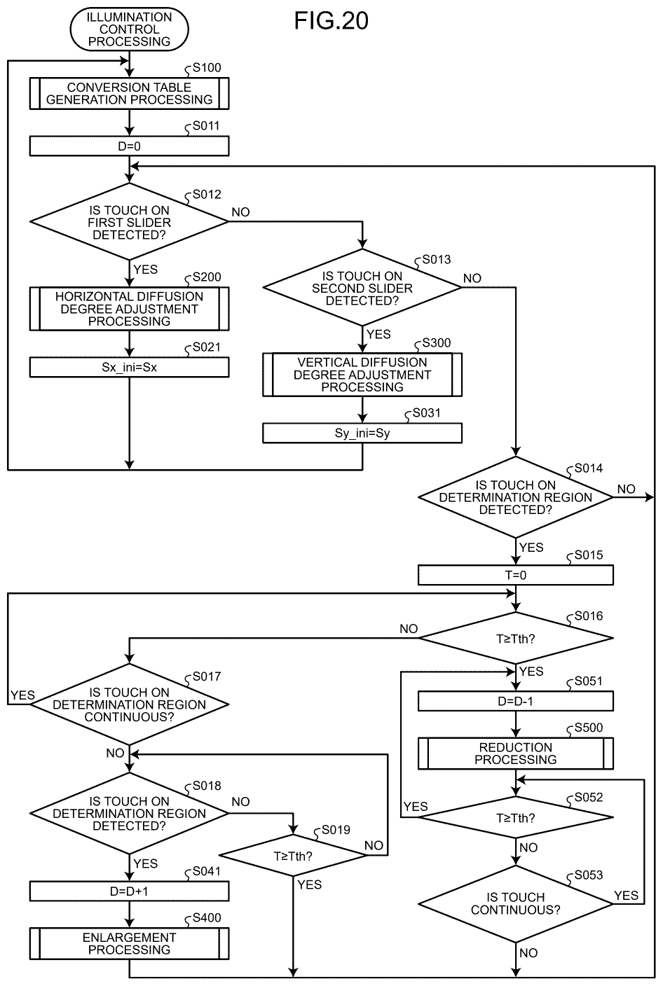

After the initial setting processing illustrated in FIG. 19 is ended, the process transitions to the illumination control processing illustrated in FIG. 20. FIG. 20 is a flowchart illustrating an example of the overall sequence of the illumination control processing by the control device 200 according to the embodiment.

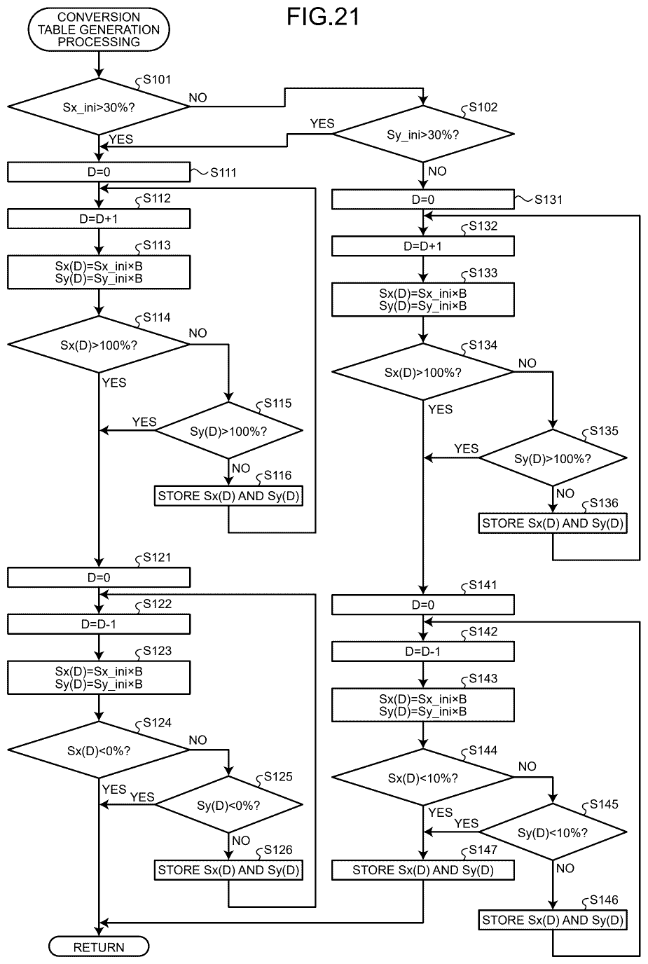

In a standby state after the initial setting processing is ended, the control device 200 executes the conversion table generation processing (step S100). FIG. 21 is a flowchart illustrating an example of the conversion table generation processing.

The processing circuit 210 of the control device 200 determines whether the horizontal diffusion degree initial value Sx_ini and the vertical diffusion degree initial value Sy_ini stored in the storage circuit 223 exceed 30% (Sx_ini>30% at step S101 and Sy_ini>30% at step S102).

If at least one of the horizontal diffusion degree initial value Sx_ini and the vertical diffusion degree initial value Sy_ini exceeds 30% (Sx_ini>30%; Yes at step S101, or Sy_ini>30%; Yes at step S102), the processing circuit 210 initializes the first variable D (D=0; step S111), increments the first variable D (D=D+1; step S112), and multiplies each of the horizontal diffusion degree initial value Sx_ini and the vertical diffusion degree initial value Sy_ini by the second variable B, thereby calculating a horizontal diffusion degree Sx(D) and a vertical diffusion degree Sy(D) for the first variable D (Sx(D)=Sx_ini×B and Sy(D)=Sy_ini×B; step S113).

The processing circuit 210 determines whether the horizontal diffusion degree Sx(D) and the vertical diffusion degree Sy(D) thus calculated exceeds 100% (Sx(D)>100%; step S114, and Sy(D)>100%; step S115).

If the horizontal diffusion degree Sx(D) and the vertical diffusion degree Sy(D) are both equal to or lower than 100% (Sx(D)≤100%; No at step S114, and Sy(D)≤100%; No at step S115), the processing circuit 210 stores the horizontal diffusion degree Sx(D) and the vertical diffusion degree Sy(D) corresponding to the first variable D in the storage circuit 223 (step S116), and re-executes processing starting at step S112.

If at least one of the horizontal diffusion degree Sx(D) and the vertical diffusion degree Sy(D) exceeds 100% (Sx(D)>100%; Yes at step S114, or Sy(D)>100%; Yes at step S115), the processing circuit 210 initializes the first variable D (D=0; step S121), decrements the first variable D (D=D−1; step S122), and multiplies each of the horizontal diffusion degree initial value Sx_ini and the vertical diffusion degree initial value Sy_ini by the second variable B, thereby calculating the horizontal diffusion degree Sx(D) and the vertical diffusion degree Sy(D) for the first variable D (Sx(D)=Sx_ini×B and Sy(D)=Sy_ini×B; step S123).

The processing circuit 210 determines whether the horizontal diffusion degree Sx(D) and the vertical diffusion degree Sy(D) thus calculated is lower than 0% (Sx(D)<0%; step S124, and Sy(D)<0%; step S125).

If the horizontal diffusion degree Sx(D) and the vertical diffusion degree Sy(D) are both equal to or higher than 0% (Sx(D)≥0%; No at step S124, and Sy(D)≥0%; No at step S125), the processing circuit 210 stores the horizontal diffusion degree Sx(D) and the vertical diffusion degree Sy(D) corresponding to the first variable D in the storage circuit 223 (step S126), and re-executes processing starting at step S122.

If at least one of the horizontal diffusion degree Sx(D) and the vertical diffusion degree Sy(D) is lower than 0% (Sx(D)<0%; Yes at step S124, or Sy(D)<0%; Yes at step S125), the process returns to the illumination control processing illustrated in FIG. 20. Through the above-described processing at steps S111 to S126, the conversion table illustrated in FIG. 18D in a case where at least one of the horizontal diffusion degree initial value Sx_ini and the vertical diffusion degree initial value Sy_ini exceeds 30% is generated and stored in the storage circuit 223. If the horizontal diffusion degree initial value Sx_ini and the vertical diffusion degree initial value Sy_ini are both equal to or lower than 30% (Sx_ini≤30%; No at step S101, and Sy_ini≤30%; No at step S102), the processing circuit 210 initializes the first variable D (D=0; step S131), increments the first variable D (D=D+1; step S132), and multiplies each of the horizontal diffusion degree initial value Sx_ini and the vertical diffusion degree initial value Sy_ini by the second variable B, thereby calculating the horizontal diffusion degree Sx(D) and the vertical diffusion degree Sy(D) for the first variable D (Sx(D)=Sx_ini×B and Sy(D)=Sy_ini×B; step S133).

The processing circuit 210 determines whether the horizontal diffusion degree Sx(D) and the vertical diffusion degree Sy(D) thus calculated exceeds 100% (Sx(D)>100%; step S134, and Sy(D)>100%; step S135).

If the horizontal diffusion degree Sx(D) and the vertical diffusion degree Sy(D) are both equal to or lower than 100% (Sx(D)≤100%; No at step S134, and Sy(D)≤100%; No at step S135), the processing circuit 210 stores the horizontal diffusion degree Sx(D) and the vertical diffusion degree Sy(D) corresponding to the first variable D in the storage circuit 223 (step S136), and re-executes processing starting at step S132.

If at least one of the horizontal diffusion degree Sx(D) and the vertical diffusion degree Sy(D) exceeds 100% (Sx(D)>100%; Yes at step S134, or Sy(D)>100%; Yes at step S135), the processing circuit 210 initializes the first variable D (D=0; step S141), decrements the first variable D (D=D−1; step S142), and multiplies each of the horizontal diffusion degree initial value Sx_ini and the vertical diffusion degree initial value Sy_ini by the second variable B, thereby calculating the horizontal diffusion degree Sx(D) and the vertical diffusion degree Sy(D) for the first variable D (Sx(D)=Sx_ini×B and Sy(D)=Sy_ini×B; step S143).

The processing circuit 210 determines whether the horizontal diffusion degree Sx(D) and the vertical diffusion degree Sy(D) thus calculated are lower than 10% (Sx(D)<10%; step S144, and Sy(D)<10%; step S145).

If the horizontal diffusion degree Sx(D) and the vertical diffusion degree Sy(D) are both equal to or higher than 10% (Sx(D)≥10%; No at step S144, and Sy(D)≥10%; No at step S145), the processing circuit 210 stores the horizontal diffusion degree Sx(D) and the vertical diffusion degree Sy(D) corresponding to the first variable D in the storage circuit 223 (step S146), and re-executes processing starting at step S142.

If at least one of the horizontal diffusion degree Sx(D) and the vertical diffusion degree Sy(D) is lower than 10% (Sx(D)<10%; Yes at step S144, or Sy(D)<10%; Yes at step S145), the horizontal diffusion degree Sx(D) and the vertical diffusion degree Sy(D) corresponding to the first variable D are stored in the storage circuit 223 (step S147), and the process returns to the illumination control processing illustrated in FIG. 20. Through the above-described processing at steps S131 to S147, the conversion table illustrated in FIG. 18E in a case where the horizontal diffusion degree initial value Sx_ini and the vertical diffusion degree initial value Sy_ini are both equal to or lower than 30% is generated and stored in the storage circuit 223.

If the conversion table generation processing is ended (step S100), the processing circuit 210 of the control device 200 initializes the first variable D (D=0; step S011) and determines whether a touch on the first slider S1 is detected (step S012), whether a touch on the second slider S2 is detected (step S013), and whether a touch on the determination region TA is detected (step S014). If none of a touch on the first slider S1, a touch on the second slider S2, and a touch on the determination region TA are detected (No at step S012; No at step S013; No at step S014), processing starting at step S012 is re-executed. The order of processing at steps S012, S013, and S014 is not limited to the aspect illustrated in FIG. 20. For example, whether a touch on the first slider S1 is detected (step S012) and whether a touch on the second slider S2 is detected (step S013) may be determined after whether a touch on the determination region TA is detected (step S014) is determined.

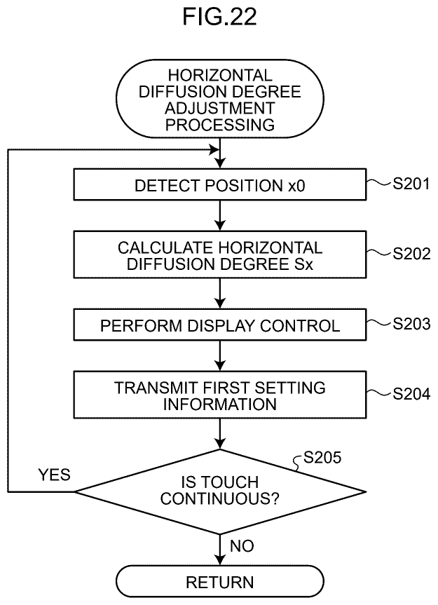

If a touch on the first slider S1 is detected (Yes at step S012), the processing circuit 210 of the control device 200 executes the horizontal diffusion degree adjustment processing (step S200). FIG. 22 is a flowchart illustrating an example of the horizontal diffusion degree adjustment processing.

The processing circuit 210 detects the position x0 (touch detection position in the X direction) of the first slider S1 on the display region DA (step S201) and calculates the horizontal diffusion degree Sx corresponding to the position x0 (step S202). The horizontal diffusion degree Sx calculated by the processing circuit 210 is reflected to display control on the illumination control application screen 400 by the display control circuit 231 (step S203) and transmitted as the first setting information (horizontal diffusion degree S1x) to the illumination device 1 by the transmission-reception circuit 225 (step S204).

The processing circuit 210 determines whether the touch on the first slider S1 is continuous (step S205); if the touch on the first slider S1 is continuous (Yes at step S205), repeatedly executes processing starting at step S201; and if the touch on the first slider S1 is not continuous (No at step S205), returns to the illumination control processing illustrated in FIG. 20, stores the latest horizontal diffusion degree Sx calculated in the horizontal diffusion degree adjustment processing (step S200) in the storage circuit 223 as the horizontal diffusion degree initial value Sx_ini (step S021), and executes the conversion table generation processing (step S100) again based on the latest horizontal diffusion degree initial value Sx_ini. Accordingly, the conversion table of the horizontal diffusion degree is updated and stored in the storage circuit 223.

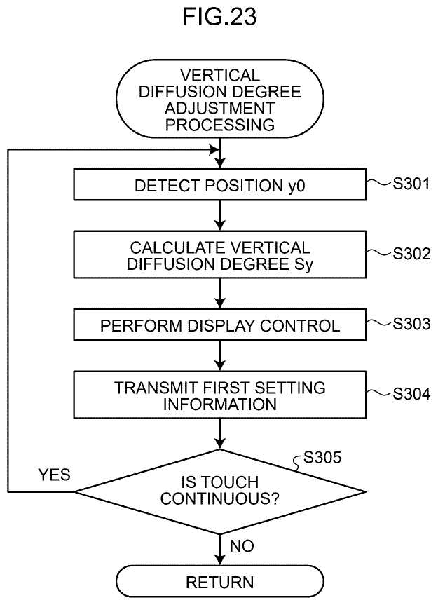

If a touch on the second slider S2 is detected (Yes at step S013), the processing circuit 210 of the control device 200 executes the vertical diffusion degree adjustment processing (step S300). FIG. 23 is a flowchart illustrating an example of the vertical diffusion degree adjustment processing.

The processing circuit 210 detects the position y0 (touch detection position in the Y direction) of the second slider S2 on the display region DA (step S301) and calculates the vertical diffusion degree Sy corresponding to the position y0 (step S302). The vertical diffusion degree Sy calculated by the processing circuit 210 is reflected to display control on the illumination control application screen 400 by the display control circuit 231 (step S303), and transmitted as the first setting information (vertical diffusion degree S1y) to the illumination device 1 by the transmission-reception circuit 225 (step S304).

The processing circuit 210 determines whether the touch on the second slider S2 is continuous (step S305); if the touch on the second slider S2 is continuous (Yes at step S305), repeatedly executes processing starting at step S301; and if the touch on the second slider S2 is not continuous (No at step S305), returns to the illumination control processing illustrated in FIG. 20, stores the latest vertical diffusion degree Sy calculated in the vertical diffusion degree adjustment processing (step S300) in the storage circuit 223 as the vertical diffusion degree initial value Sy_ini (step S031), and executes the conversion table generation processing (step S100) again based on the latest vertical diffusion degree initial value Sy_ini. Accordingly, a conversion table of the vertical diffusion degree is generated and stored in the storage circuit 223.

If a touch on the determination region TA is detected (Yes at step S014), the processing circuit 210 of the control device 200 resets a timer T for determination of a touch operation in the determination region TA (T=0; step S015) and determines whether a predetermined time threshold Tth (for example, one second) has elapsed (T≥Tth; step S016). If the time threshold Tth has not elapsed (T<Tth; No at step S016), the processing circuit 210 determines whether the touch on the determination region TA is continuous (step S017), and returns to processing at step S016 if the touch on the determination region TA is continuous (Yes at step S017).

If the touch on the determination region TA is not continuous (No at step S017), the processing circuit 210 determines whether a touch on the determination region TA is detected again (step S018). If a touch on the determination region TA is not detected (No at step S018), the processing circuit 210 determines whether the time threshold Tth has elapsed (T≥Tth; step S019). If the time threshold Tth has elapsed (T≥Tth; Yes at step S019), the process returns to processing at step S012. If the time threshold Tth has not elapsed (T<Tth; No at step S019), the process returns to processing at step S018.

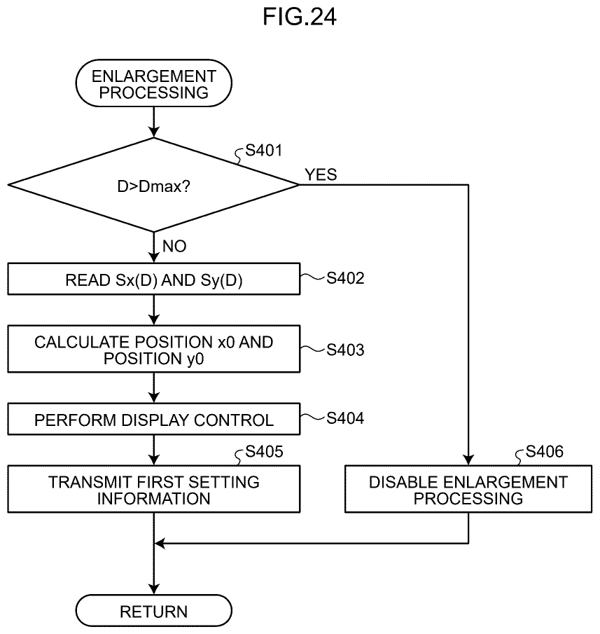

If a touch on the determination region TA is detected again in processing at step S018 (Yes at step S018), the processing circuit 210 determines that the determination region TA is double-tapped on the illumination control application screen 400, increments the first variable D (D=D+1; step S041), and executes the enlargement processing (step S400). FIG. 24 is a flowchart illustrating an example of the enlargement processing.

The processing circuit 210 refers to a conversion table stored in the storage circuit 223 and determines whether the first variable D exceeds the maximum value Dmax (D>Dmax; step S401).

If the first variable D is equal to or smaller than the maximum value Dmax (D≤Dmax; No at step S401), the processing circuit 210 reads the horizontal diffusion degree Sx(D) and the vertical diffusion degree Sy(D) corresponding to the first variable D from the conversion table (step S402), and calculates the position x0 of the first slider S1 on the display region DA and the position y0 of the second slider S2 on the display region DA (step S403). The display control circuit 231 reflects, to display control on the illumination control application screen 400, the horizontal diffusion degree Sx(D), the vertical diffusion degree Sy(D), the position x0 of the first slider S1 on the display region DA, and the position y0 of the second slider S2 on the display region DA (step S404), and the transmission-reception circuit 225 transmits the horizontal diffusion degree Sx(D) and the vertical diffusion degree Sy(D) to the illumination device 1 as the first setting information (horizontal diffusion degree S1x and vertical diffusion degree S1y) (step S405), and then returns to the illumination control processing illustrated in FIG. 20, thereby returning to processing at step S012.

The transmission-reception circuit 111 of the illumination device 1 stores the first setting information (horizontal diffusion degree S1x and vertical diffusion degree S1y) transmitted from the control device 200, in the storage circuit 113 as the new horizontal diffusion degree S2x and vertical diffusion degree S2y. The electrode drive circuit 112 of the illumination device 1 supplies drive voltage based on the horizontal diffusion degree S2x and the vertical diffusion degree S2y stored in the storage circuit 113 by the processing circuit 210 to the drive electrodes 10 and 13 of each liquid crystal cell 2 of the optical element 100.

If the first variable D exceeds the maximum value Dmax in processing at step S401 (D>Dmax; Yes at step S401), the processing circuit 210 disables the enlargement processing (step S406) and returns to the illumination control processing illustrated in FIG. 20, thereby returning to processing at step S012. In this case, a warning indicating that the irradiation range of light from the illumination device 1 is maximum may be displayed on the illumination control application screen 400. This warning display may be text display or may involve change in the colors of the light distribution shape object OBJ and horizontal and vertical diffusion degree display values (for example, to red). Alternatively, instead of displaying a warning, the user may be notified that the irradiation range of light from the illumination device 1 is maximum by means of a vibration function of the control device 200.

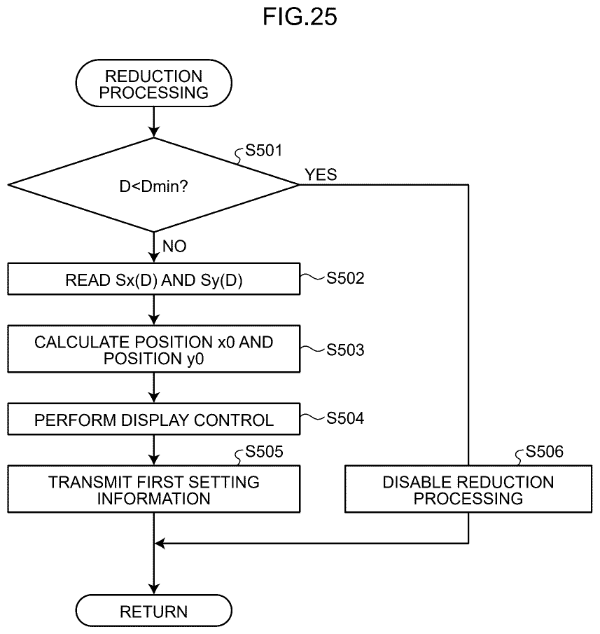

If the time threshold Tth has elapsed in processing at step S016 (T≥Tth; Yes at step S016), the processing circuit 210 determines that the determination region TA is long-tapped on the illumination control application screen 400, decrements the first variable D (D=D−1; step S051), and executes the reduction processing (step S500). FIG. 25 is a flowchart illustrating an example of the reduction processing.

The processing circuit 210 refers to a conversion table stored in the storage circuit 223 and determines whether the first variable D is smaller than the minimum value Dmin (D<Dmin; step S501).

If the first variable D is equal to or larger than the minimum value Dmin (D≥Dmin; No at step S501), the processing circuit 210 reads the horizontal diffusion degree Sx(D) and the vertical diffusion degree Sy(D) corresponding to the first variable D from the conversion table (step S502), and calculates the position x0 of the first slider S1 on the display region DA and the position y0 of the second slider S2 on the display region DA (step S503).

The display control circuit 231 reflects, to display control on the illumination control application screen 400, the horizontal diffusion degree Sx(D), the vertical diffusion degree Sy(D), the position x0 of the first slider S1 on the display region DA, and the position y0 of the second slider S2 on the display region DA (step S504), and the transmission-reception circuit 225 transmits the horizontal diffusion degree Sx(D) and the vertical diffusion degree Sy(D) to the illumination device 1 as the first setting information (horizontal diffusion degree S1x and vertical diffusion degree S1y) (step S505).

The transmission-reception circuit 111 of the illumination device 1 stores the first setting information (horizontal diffusion degree S1x and vertical diffusion degree S1y) transmitted from the control device 200 in the storage circuit 113 as the new horizontal diffusion degree S2x and vertical diffusion degree S2y. In addition, the electrode drive circuit 112 of the illumination device 1 supplies drive voltage based on the horizontal diffusion degree S2x and the vertical diffusion degree S2y stored in the storage circuit 113 by the processing circuit 210 to the drive electrodes 10 and 13 of each liquid crystal cell 2 of the optical element 100.

Thereafter, returning to the illumination control processing illustrated in FIG. 20, the processing circuit 210 determines whether the time threshold Tth has elapsed (T≥Tth; step S052).

If the time threshold Tth has not elapsed (T<Tth; No at step S052), it is determined whether the touch is continuous (step S053). If the touch is not continuous (No at step S053), the process returns to processing at step S012. If the touch is continuous (Yes at step S053), the process returns to processing at step S052. Then, if the time threshold Tth has elapsed (Yes at step S052), the process returns to processing at step S051, the first variable D is decremented (D=D−1; step S051) and the reduction processing is executed (step S500) again.

Subsequently, the control device 200 repeatedly executes the reduction processing (step S500) until the touch is no longer continuous (No at step S053).

If the first variable D is smaller than the minimum value Dmin in processing at step S501 (D<Dmin; Yes at step S501), the processing circuit 210 disables the reduction processing (step S506) and returns to the illumination control processing illustrated in FIG. 20. In this case, a warning indicating that the irradiation range of light from the illumination device 1 is minimum may be displayed on the illumination control application screen 400. This warning display may be text display or may involve change in the colors of the light distribution shape object OBJ and horizontal and vertical diffusion degree display values (for example, to red). Alternatively, instead of displaying a warning, the user may be notified that the irradiation range of light from the illumination device 1 is minimum by means of a vibration function of the control device 200.

Through the illumination control processing described above, the control device 200 for the illumination device 1 according to the embodiment increases the horizontal diffusion degree and the vertical diffusion degree at identical or substantially identical ratios when a double tap (first touch operation) is detected in the determination region TA and decreases the horizontal diffusion degree and the vertical diffusion degree at identical or substantially identical ratios when a long tap (second touch operation) is detected in the determination region TA. Then, the horizontal diffusion degree and the vertical diffusion degree are increased at identical or substantially identical ratios each time a double tap (first touch operation) is detected, and the horizontal diffusion degree and the vertical diffusion degree are decreased at identical or substantially identical ratios each time a long tap (second touch operation) is detected. Accordingly, the irradiation area of light from the illumination device 1 can be intuitively enlarged or reduced while the light distribution shape is maintained. Specifically, the user can enlarge and reduce the light distribution shape by operating the first slider S1 and the second slider S2 on the illumination control application screen 400 to adjust the light distribution shape and then double-tapping or long-tapping a predetermined region on the illumination control application screen 400 while the light distribution shape is maintained. Moreover, by operating the first slider S1 and the second slider S2 again to update the light distribution shape while the enlargement and reduction operation is performed, and thereafter double-tapping or long-tapping a predetermined region on the illumination control application screen 400, the user can perform the enlargement and reduction operation with the updated light distribution shape.

In the present disclosure, the light distribution shape object OBJ is reduced by the reduction processing (FIG. 25), and as a result, a position that is long-tapped by the user potentially becomes out of the determination region TA. Thus, at step S053 of the illumination control processing (FIG. 20), it is determined whether a touch is continuous in the detection region FA. For example, the determination region TA is set to a region that does not change through the enlargement processing (FIG. 24) and the reduction processing (FIG. 25), whereby it can be determined whether a touch on the determination region TA is continuous at step S053 of the illumination control processing (FIG. 20) in the same manner as at step S017. In this case, examples of the region that does not change through the enlargement processing (FIG. 24) and the reduction processing (FIG. 25) include the region inside the outline of the light distribution shape object OBJ when the horizontal diffusion degree Sx is 100% and the vertical diffusion degree Sy is 100%, and the region inside the outline of the light distribution shape object OBJ when the horizontal diffusion degree Sx is 0% and the vertical diffusion degree Sy is 0% (refer to FIG. 16). Moreover, when the determination region TA is set to a region that does not change through the enlargement processing (FIG. 24) and the reduction processing (FIG. 25), a position that is double-tapped or long-tapped by the user on the detection region FA does not need to be intentionally changed in response to change in the light distribution state, and thus the irradiation area of light from the illumination device 1 can be more intuitively enlarged or reduced.

In the exemplary configuration described in the above-described embodiment, the diffusion degree of the optical element 100 is controllable in two directions (the horizontal diffusion degree and the vertical diffusion degree) to control the light distribution shape of light from the illumination device 1 in two directions of the Dx and Dy directions, but the enlargement processing and the reduction processing in the present disclosure may be applied to configurations for controlling the diffusion degree in all directions uniformly. Specifically, the enlargement processing and the reduction processing in the present disclosure are also applicable to, for example, a configuration in which the size of the substantially circular light distribution shape object OBJ (the irradiation area of light from the illumination device 1) is changed by one slider provided on the illumination control application screen 400 (adjustment screen).

The preferable embodiments of the present disclosure are described above, but the present disclosure is not limited to the embodiments. Contents disclosed in the embodiments are merely exemplary and may be modified in various kinds of manners without departing from the scope of the present disclosure. For example, in a case where an illumination device of the present disclosure is adjustable with respect to not only the light distribution shape but also brightness and light color, the configuration of the present disclosure may be used to change the brightness and light color through touch operation on a determination region. Appropriate modifications made without departing from the scope of the present disclosure naturally belong to the technical scope of the present disclosure.

What is claimed is:

1. A control device for an illumination device, the control device being configured to control an illumination device that is changeable with respect to an irradiation area by controlling a diffusion degree of light emitted from a light source, the control device comprising:
a touch sensor having a detection region provided with a plurality of detection elements; and
a display panel provided with a display region overlapping the detection region of the touch sensor in plan view, wherein
a determination region provided in the detection region and configured to detect a predetermined touch operation,
touch operations to be detected in the determination region include a first touch operation defined by at least one of the number of touches or the duration of touch in the determination region and a second touch operation different from the first touch operation,
the diffusion degree of the illumination device is increased when the first touch operation is detected, and
the diffusion degree of the illumination device is decreased when the second touch operation is detected.

2. The control device for an illumination device according to claim 1, wherein
the diffusion degree of the illumination device is increased each time the first touch operation is detected, and
the diffusion degree of the illumination device is decreased each time the second touch operation is detected.

3. The control device for an illumination device according to claim 2, wherein
one of the first touch operation and the second touch operation is a double tap in which the determination region is touched twice within a predetermined time, and
the other of the first touch operation and the second touch operation is a long tap in which a touch in the determination region is continuous for a predetermined time.

4. The control device for an illumination device according to claim 2, wherein the display panel is configured to
display an adjustment screen for adjusting the diffusion degree of the illumination device depending on a movement amount of a touch detection position in the detection region, and
set, based on a diffusion degree adjusted on the adjustment screen, a change step of the diffusion degree of the illumination device when the first touch operation and the second touch operation is detected.

5. The control device for an illumination device according to claim 4, wherein
the irradiation area is defined in two directions of a first direction and a second direction intersecting the first direction, and
the adjustment screen is defined with an X direction corresponding to the first direction, a Y direction corresponding to the second direction, and an XY plane having an origin at a predetermined position on the adjustment screen, and is provided with a light distribution shape object having a center point at the origin of the XY plane, in correspondence with the irradiation area.

6. The control device for an illumination device according to claim 5, wherein, on the adjustment screen,
a position corresponding to the diffusion degree of the illumination device is on the outline of the light distribution shape object, and
one of the shape and size of the light distribution shape object on the adjustment screen changes with a change in the diffusion degree of the illumination device.

7. The control device for an illumination device according to claim 6, wherein
the adjustment screen is provided with
a first slider overlapping an intersection point between the outline of the light distribution shape object and an X axis of the XY plane, and
a second slider overlapping an intersection point between the outline of the light distribution shape object and a Y axis of the XY plane,
the diffusion degree in the first direction is adjusted depending on a movement amount of the first slider in the X direction, and
the diffusion degree in the second direction is adjusted depending on a movement amount of the second slider in the Y direction.

8. The control device for an illumination device according to claim 7, wherein when the first touch operation or the second touch operation is detected, the diffusion degree in the first direction and the diffusion degree in the second direction are changed at identical or substantially identical ratios.

9. The control device for an illumination device according to claim 8, wherein the determination region is provided inside the outline of the light distribution shape object.
